(19) United States
(12) Patent Application Publication
(10) Pub. No.: US 2015/0130416 A1
(43) Pub. Date: May 14, 2015

(54) Sliding charging and synchronization security drawer

(71) Applicant: Scott LESIZZA, New York, NY (US)

(72) Inventor: Scott LESIZZA, New York, NY (US)

(21) Appl. No.: 14/121,333

(22) Filed: Aug. 20, 2014

Related U.S. Application Data
(60) Provisional application No. 61/901,772, filed on Nov. 8, 2013.
(60) Provisional application No. 62/009,763, filed on Jun. 9, 2014.

(51) Int. Cl. H02J 7/00

(52) U.S. Cl. CPC H02J 7/0027
USPC 320/111; 320/107

(57) ABSTRACT

A drawer and drawer insert with an electronic panel for charging and synchronizing an electronic device are disclosed. The drawer includes a receiving area positioned at a front and a flat bottom extending along a first plane and ending at a bottom transition area; and a trough or drawer belly positioned rearward of the receiving area, the trough including a trough bottom starting at the transition area and inclined down away from the front of the drawer at an angle substantially less than 90 degrees with respect to the first plane; and an electronic panel including a surface with an electronic device charging port, the surface aligning with a second plane inclining up toward a rear of the drawer, the second plane meeting the first plane at an angle substantially less than 90 degrees. The charging port may include an electric plug and a USB port.

### CROSS-REFERENCE TO RELATED APPLICATIONS

The present non-provisional patent application claims the benefit of priority from U.S. Provisional Patent Application Nos. 61/901,772, filed Nov. 8, 2013, entitled “SLIDING CHARGING AND SYNCHRONIZATION SECURITY DRAWER” and 62/009,763, filed Jun. 9, 2014, entitled “LAPTOP AND PORTABLE DEVICE CHARGING AND SYNCHRONIZATION DRAWER INSERT,” the entire contents of both of which are incorporated herein by reference.

### BACKGROUND

With the proliferation of handheld devices, mobile telephones, smart phones, electronic notepads, tablets, netbooks, e-readers, electronic personal music players and the like, the organization, security and safety of these devices have become an important concern for many consumers. Many Americans have multiple devices that need to be charged, re-charged, or synchronized at various periods of time or intermittently. These devices take up valuable space in an ever shrinking home or workspace.

Drawers and shelves can store, organize, secure and keep safe such devices. However, such devices often need to be charged so as to replenish drained internal or external batteries, and thus need an electric socket, which security drawers often lack.

However, such electronic communication devices and other such device store data, which is updated from time to time or periodically. For example, people enter new contact information, photos or the like into their smart phones, add new music to their personal electronic music players, add information, texts, PDFs or other content to their tablets, netbooks receive new e-mails, SMS or text and the like. This data needs to be backed up or synchronized with other devices.

### SUMMARY OF THE DISCLOSURE

A drawer is disclosed that includes:

a receiving area positioned at a front of the drawer and including a flat bottom extending along a first plane, the receiving area ending at a bottom transition area; and

a trough positioned rearward of the receiving area, the trough comprising:

a trough bottom positioned starting at the transition area and inclined down away from the front of the drawer at an angle substantially less than 90 degrees with respect to the first plane; and

an electronic panel including a surface comprising an electronic device charging port, the surface being positioned to align with a second plane inclining up toward a rear of the drawer, the second plane meeting the first plane at an angle substantially less than 90 degrees.

In such a drawer, the trough bottom may be substantially 90 degrees with respect to the second plane. For example, it may be 75-90 degrees. The trough bottom may be substantially 45 degrees with respect to the first plane. For example, it may be 30-60 degrees. The second plane may be substantially 45 degrees with respect to the first plane. For example, it may be 30-60 degrees with respect to the first plane.

In such a drawer, the charging port may include an electric plug, may include a synchronizing port, and/or may include a USB port.

Such a drawer may also include a second flat bottom extending from the trough bottom to the rear of the drawer.

Also described is a drawer configured to be mounted underneath a work surface supported underneath by a support bar. Such a drawer may include:

a receiving area positioned starting at a front of the drawer and including a bottom; and

walls defining a recess positioned and configured to accommodate the support bar, the recess extending from a first lateral side of the drawer to a second lateral side of the drawer,

wherein the receiving area extends underneath the recess; and

an electronic panel comprising an electronic device charging port, the electronic panel positioned in the drawer forward of the walls defining the recess.

In such a drawer, the charging port may include an electric plug, may include a synchronizing port, and/or may include a USB port.

Also described is a drawer insert configured and sized to fit inside a drawer having a lip.

Such a drawer insert may include a top portion including a top lip positioned and configured to secure on the lip of the drawer; and

an electronic panel comprising an electronic device charging port.

In such a drawer insert, the charging port may include an electric plug, may include a synchronizing port, and/or may include a USB port.

Also disclosed is a drawer configured to be mounted underneath a work surface, such that a top side is mounted to a surface underneath the work surface. In such a drawer, a lower side is positioned opposite the top side;

a receiving area includes a forward portion positioned starting at a front of the drawer and including a bottom positioned vertically, the bottom extending from the top side to the lower side; and

an electronic panel comprising an electronic device charging port,

wherein the electronic panel is positioned in the drawer forward of a rear of the drawer and recessed from the bottom, such that the receiving area extends between the electronic panel and the bottom, the receiving area configured to accommodate an electronic device positioned between the electronic panel and the bottom.

In such a drawer, the charging port may include an electric plug, may include a synchronizing port, and/or may include a USB port.

### BRIEF DESCRIPTION OF THE FIGURES

For the purposes of illustrating the invention, in the Drawings illustrate embodiments that are presently preferred, it being understood, however, that the invention is not limited to the precise arrangements and instrumentalities shown. The features and advantages of the present invention will become apparent from the following description of the invention that refers to the accompanying drawings, in which:

FIGS. 1A-1H are schematic illustrations of an example of a drawer, according to an aspect of the present disclosure.

FIG. 2 illustrates another example of a drawer with a trough, according to an aspect of the present disclosure.

FIGS. 3A-3H illustrate several views of an example of the drawer with the trough, according to an aspect of the present disclosure.

FIG. 4 illustrates an example of a bottom view of the drawer with the trough, according to an aspect of the present disclosure.

FIG. 5 illustrates another bottom and rear view of the drawer with the trough, according to an aspect of the present disclosure.

FIG. 6 illustrates an example of a bottom of the drawer with the trough, according to an aspect of the present disclosure.

FIG. 7 is an example of a front view of the drawer with a trough, according to an aspect of the present disclosure.

FIG. 8 is a perspective view illustration of an example of a drawer insert, according to an aspect of the disclosure.

FIGS. 9A-9E is a schematic illustration of an example of a drawer insert, according to an aspect of the present disclosure.

FIGS. 10A-10D is a schematic illustration of an example of a drawer insert with a side mounted electrical panel, according to an aspect of the present disclosure.

FIGS. 10E-10F is a schematic illustration of an example of a drawer insert front interior view according to an aspect of the present disclosure.

FIGS. 11A-11F is a schematic illustration of an example of a drawer insert according to an aspect of the present disclosure.

FIGS. 12A-12C illustrate an example of a vertically mountable drawer, according to an aspect of the present disclosure.

FIGS. 13A-H illustrate an example of a drawer with a recess to accommodate a support bar, according to an aspect of the present disclosure.

FIG. 14 illustrates an example of a drawer with a recess to accommodate an under desk support bar according to an aspect of the present disclosure.

### DETAILED DESCRIPTION OF THE EMBODIMENTS

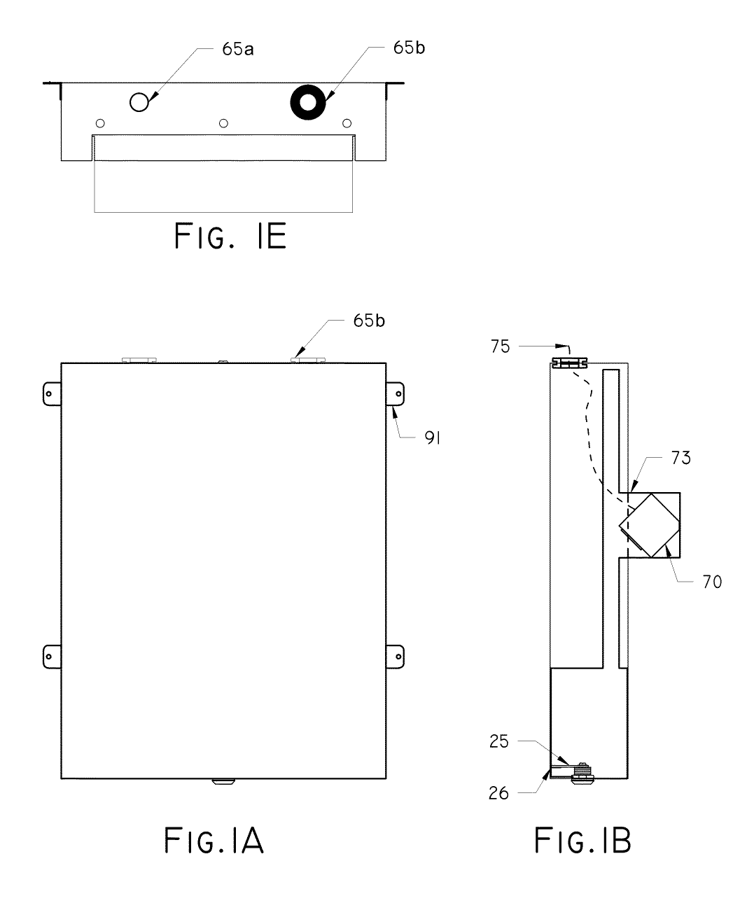

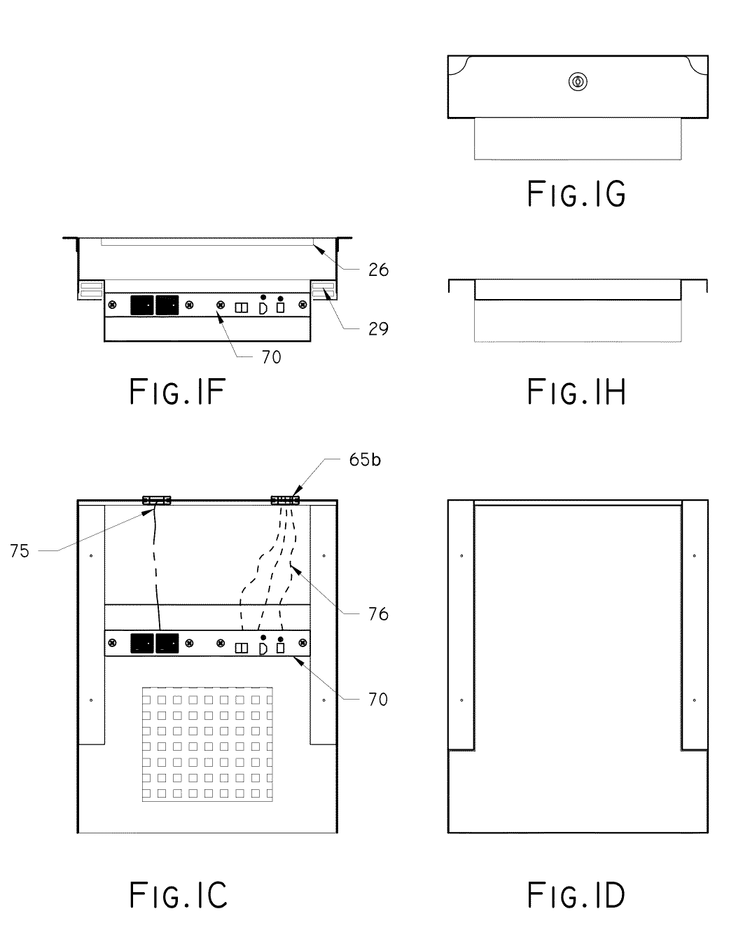

FIG. 1 illustrates a security drawer 20, which may be positioned under a desk surface and above a filing cabinet. FIG. 1F illustrates details including sliding mechanism 23 that is attached to top panel portion of drawer 20. Sliding mechanism 23 allows the drawer to be slid in or slid out. Top panel 21 may be attached to a surface, such as to a desk, table, nightstand or night table, or other type of surface or the like above the drawer using screws, bolts or other attachment devices. For example, top panel 21 may be attached using 4-28 screws or both to allow for convenient attachment. Top panel 21 may have a large opening at the center such that only the sides and or the rear needed for mounting the drawer and a front frame are present. Drawer 20 may be made of aluminum, steel, or other metals or metal alloys, plastic, or a combination of the foregoing materials.

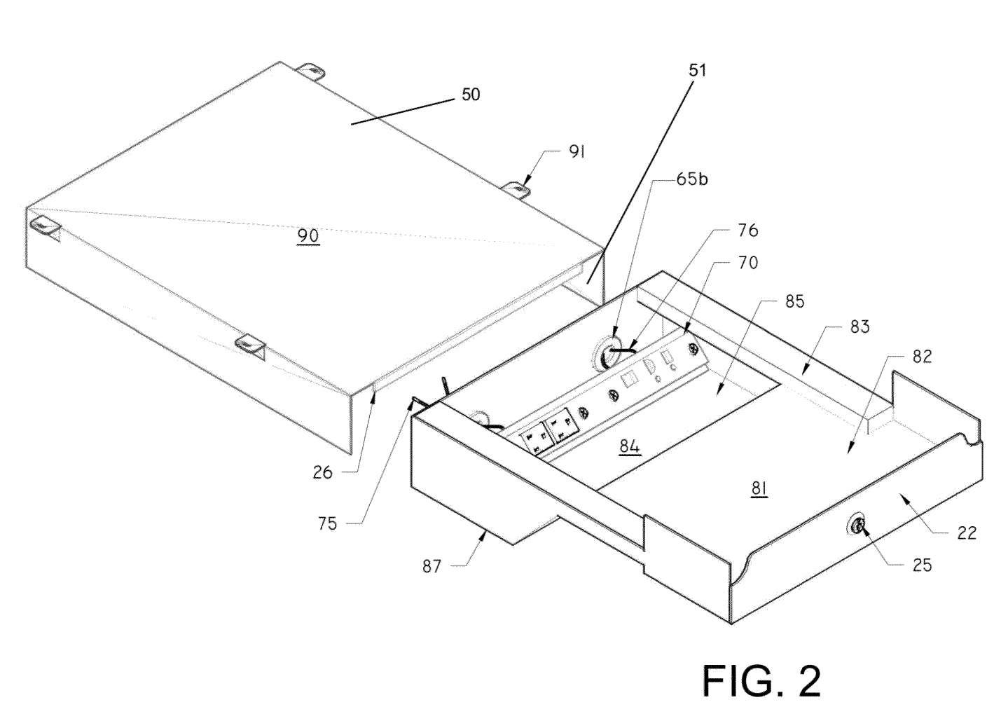

FIG. 2 also illustrates lock 25 that is used to secure the content of drawer 20. Lock 25 may be opened with a key or may be a combination lock. Keycard locks of the mechanical hole-card type, magnetic stripe, bar code, smartcards with embedded microchip, and RFID proximity cards are also contemplated.

An inside of the drawer without the top panel is illustrated in FIG. 1C. The inside 30 of the drawer includes front portion 31, which can store smaller handheld devices, such as personal organizers, personal music players, including iPods and the like, mobile phones, including smart phones, and other such devices. Inner space 30 also includes top portion 33, which can accommodate larger devices, such as laptops, netbooks, tablets, e-readers, electronic pads and the like. Inside 30 may also accommodate chargers, cords, joysticks, keypads, keyboards, headphones, flash memories, satellite wands, carrying and protective cases and other accessories of such devices.

FIG. 1F illustrates electronic panel 40 inside drawer 20, which can include plugs and ports for connecting with the electronic devices inside the drawer. FIG. 1F illustrates, by way of example, electronic outlet, and USB ports. It will be understood that fewer or a greater number of such electronic outlets and ports can be provided on panel 40, and that other kinds of electronic outlets such as European style or Asian style electric outlets that provide 220 or more volts, direct current, or the like can also be provided. Panel 40 may include a surge protector with ground so as to protect the electronic devices connected therewith.

In addition, other types of ports, such as Ethernet ports, telephone jacks, “Firewire” ports, jacks for headphones or microphones, coaxial cable jacks, and/or HDMI ports or the like, can be provided in addition to, or instead of, the ports shown in 1F.

FIG. 1F also illustrates that panel 40 is secured using screws, however it will be understood that it may be secured using other fastening means.

Behind panel 40, cords connect the electronic outlets 45a-45c to electric power (not shown), and cables (not shown) connect the USB ports or other ports to a personal computer, laptop, netbook, computer network or the like. In this way, devices stored in the drawer 20 can be simultaneously recharged and/or synchronized with the user's home or office personal computer, laptop, netbook or other electronic device or the like, and/or with “cloud” or on-line storage or other off-site servers.

It will be understood that door 22 may be tiltable so as to afford greater access for the user, and may additionally be removable after being opened.

FIG. 2 illustrates lip 26, which may be provided on top panel so as to secure drawer 20 in the locked position behind door 22.

Lock 25 may be positioned in the middle or on the side. The drawer can accommodate one or more larger device such as a notebook computer, laptop computer, e-reader, e-pad or tablet. Smaller electronic devices, and personal items, such as sunglasses inside the drawer. Devices may be plugged into the USB port 47 so that they can sync with a device (not shown) connected to the port. For example, such synchronization can comprise uploading and/or saving and/or backing up data from the device in the drawer to the “home” device or office device of the user. The synching may involve two-way synchronization of data from the user device inside the drawer with the device to which the port is connected.

Some ports may be located at the back of drawer 20 so as to allow more convenient coupling of the port with a cord located behind the drawer 20 with the home or office computer or laptop, for example, positioned on the desk on top of drawer 20. In this example, electric outlets 45a-45c can be located as part of power strip, such as a power strip with surge protection on the side of the drawer, such that the cord of the power strip is positioned at the rear of the drawer.

It will be understood that all electrical outlets, ports and jacks may be located on the same panel, for example, at one side or at the rear of drawer 20. Or, some electrical outlets, ports and jacks may be provided at one portion, for example at one side of drawer 20, while other electrical outlets, ports and jacks may be provided at another side, at the front portion behind or as part of the front panel, or at the rear of drawer 20.

One or more receiving pads may be positioned on the bottom of drawer 20 to prevent abrasion of devices stored therein. Receiving pads may be made of metal, plastic, rubber or a combination of the foregoing, and may have a non-slip surface and may be slightly raised with respect to the remaining portion of the bottom of the drawer 20. In this way, electronic devices are less likely to be unduly shaken or bashed with opening and closing of drawer 20. Drawer 20 may accommodate one or more cables inserted into the front of drawer 20, even when the drawer is in the locked position, and the cable may be attached to a port or to an electric outlet inside drawer 20.

Additional ports may be positioned at the back of drawer 20. One or more such additional port may be an Ethernet port, and a USB port 47. Electric outlet 45b may be positioned at a different orientation or angle than first electric outlet 45a, and electric outlet 45c oriented and positioned in a different angle then both of electric outlets 45a and 45b. This may facilitate the recharging or charging of various types of electronic devices irrespective of how their power ports are configured.

One or more holes, slits or vents (not shown) may be positioned on the bottom of drawer 20 so as to avoid excessive heat buildup during charging or recharging or during synching, transmitting of signals, searching for a signal or cellphone tower, or other operation of the devices inside drawer 20.

Vents may open directly to a bottom of drawer 20 so as to provide airflow between a bottom of drawer 20 and the outside of the drawer underneath. One or more additional vents may be provided near the back of drawer 20. Vents can also be used to snake through electric power cords or other types of cords to connect the devices in drawer 20 with the home or office computer. The sides of drawer 20 may include side vents positioned in the middle below or on top of drawer sliding mechanism 23. Conventional drawers can trap heat, and electronic devices charging or operating therein can be damaged thereby or surrounding items or the furniture may be damaged. Fires can ensue without proper ventilation. It will be understood that additional vents or fewer vents than the number shown and vents with different configurations than the ones shown may be used.

A drawer as provided herein can reduce clutter and snaking of wires across a workspace or desk area and can enable easier connection with an electric outlet as well as with ports for synchronizing with a home computer, work computer or the like. Many of a person's mobile electronic devices that require recharging and/or synching or backup can be neatly organized in one safe and secure place. In addition, drawer 20 can be a convenient place to store neatly and securely electric chargers for such devices as well as other accessories, such as headphones, microphones, speakers, disks, joysticks, keypads, keyboards, batteries, chargers, cords, travel cases and carriers, SIM cards, memory cards, external drives, disks, wands, flash memory sticks, or the like, and/or other personal items, in a convenient and accessible manner.

Further, drawer 20 can prevent or deter theft or misplacement, and can provide security for the electric devices stored therein. Drawer 20 can provide safety, such as protection from water, heat, sunlight or fire.

FIG. 2 illustrates a bracket 50 that can surround drawer 50. The bracket may serve as a universal adapter for the drawer so that the drawer 20 can be mounted beneath various types of work surfaces, desks or in other spaces, including furniture work stations that have a support bar underneath that may obstruct all or part of the mounting of the drawer 20. As illustrated in FIG. 2, bracket 50 includes a sleeve or recess 51, that allows bracket 50 to be installed around any such support bar or other obstruction on the mounting surface.

FIG. 2 illustrates drawer 20 in an open position with respect to bracket 50. Sliding mechanism 23 of drawer 20 is thus positioned inside bracket 50 to allow drawer 20 to open and to close with respect to bracket 50. Bracket 50 can thus also enhance the security of drawer 20 since it tends to disallow tampering with the sides of drawer 20. In addition, bracket 50 may also inhibit removal of drawer 20 from the surface to which it is attached by loosening the screws or bolts that attach drawer 20 to the surface. This is because screw holes 53 of bracket 50 are difficult to access when drawer 20 is inside bracket 50 and in the locked position. Thus, a self-contained unit comprising bracket 50 and drawer 20 may be provided.

FIG. 2 illustrates an example of a perspective view of drawer 20 and a partial view of bracket 50. As illustrated in FIG. 2, drawer 20 is large enough to accommodate the notebook computers, laptops, tablets, smart phones and other handheld or other mobile personal electronic devices discussed above, as well as the power strip and ports and jacks and their cords, above-referenced. Cords attached to electronic panel 40 inside drawer 20 as well as cords or other wires that provide the USB port and other ports or jacks may be threaded through rear portion 55 of bracket 50 or through a bottom thereof. For example, bracket 50 may lack an entirety of or a portion of a bottom. Accordingly, a bottom of drawer 20 may be the only bottom for holding the electronic devices inside. According to this aspect of the disclosure, vents on the bottom of drawer 20 can remain unobstructed to dissipate heat from drawer 20.

Accordingly, electronic devices can be securely stored in a drawer and such devices can be protected from theft, being lost or misplaced, blocked from direct sunlight or the like, and at the same time, such electronic devices can be electrically charged or recharged and data stored therein can be synchronized. The synchronization or synching may involve one way or two-way synchronization of data between the user device inside the drawer or drawer insert with a computer located near the drawer to which the electronic device is connected via the one or more ports or jacks shown. The electronic panel 70 may also include or be connected to a surge protector for electric outlets 45a, 45b.

According to another aspect of the disclosure, the drawer may include a “belly” or trough that includes electronic panel 40 and cables and electronics thereof. Such a drawer is illustrated, in FIG. 2.

The drawer with a trough may include receiving area 81, with a flat bottom or substantially flat bottom 82 that can receive and hold electronic devices, such as those mentioned above. Receiving area 81 may be immediately behind door 22 at the front of the Drawer. The rearward portion of receiving area 81, sometimes referred to herein as transition area 83 transitions into inclined bottom area of the trough bottom 85. The trough is generally shown as 84. Trough bottom 85 may be inclined down and away from the front portion of the drawer at an angle with respect to the plane of flat bottom 82 of receiving area 81. Trough bottom 85 may be 45° or substantially 45° with respect to flat bottom 82 of receiving area 81, or may be at some other angle less than 90° with respect to the plane of flat bottom 82. As described herein, terms such 45° or 90° or the like means within the standard tolerance in the art for such angles. Terms such as substantially 45° or substantially 90° or other such angles as described herein may mean the angle+/−15° of the angle described. Substantially less than 90 degrees may mean 65 degrees or less, and preferably may mean 50 degrees or less.

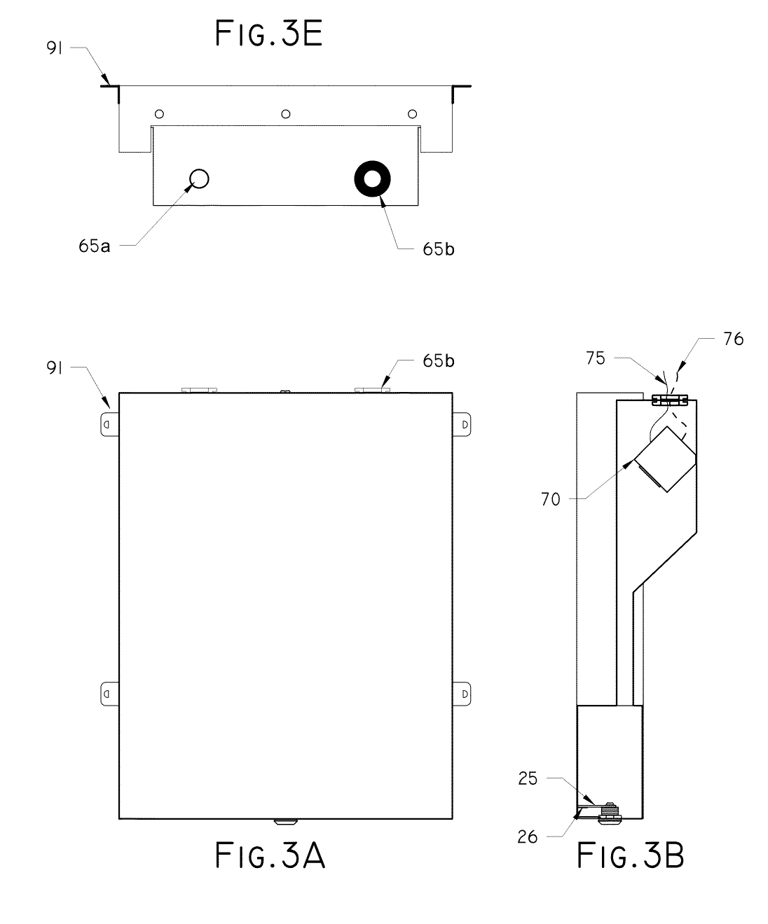

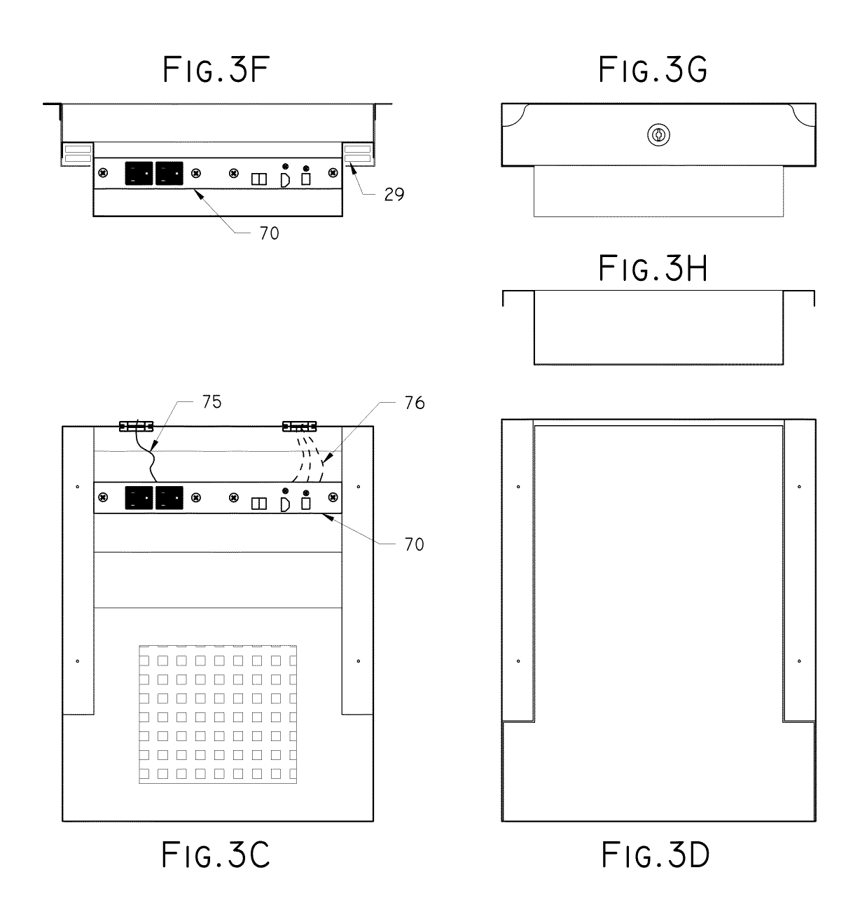

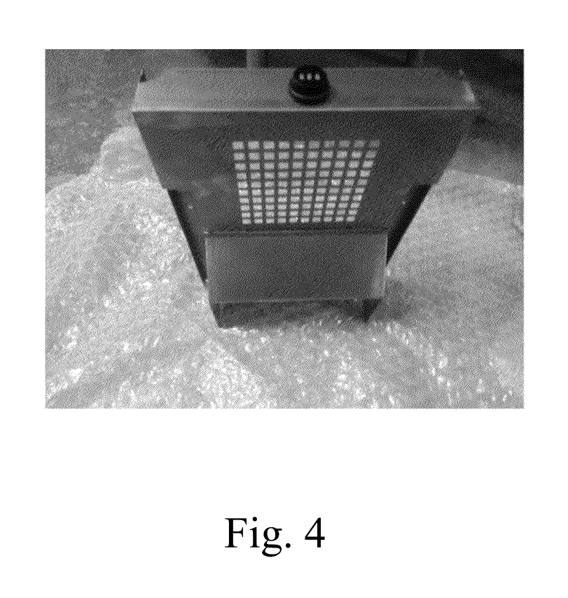

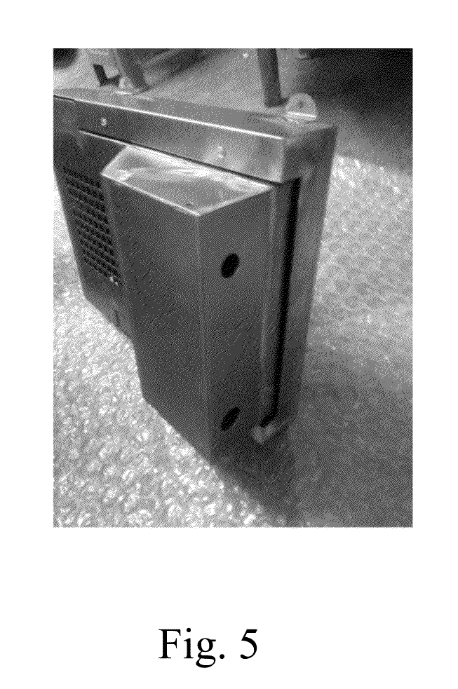

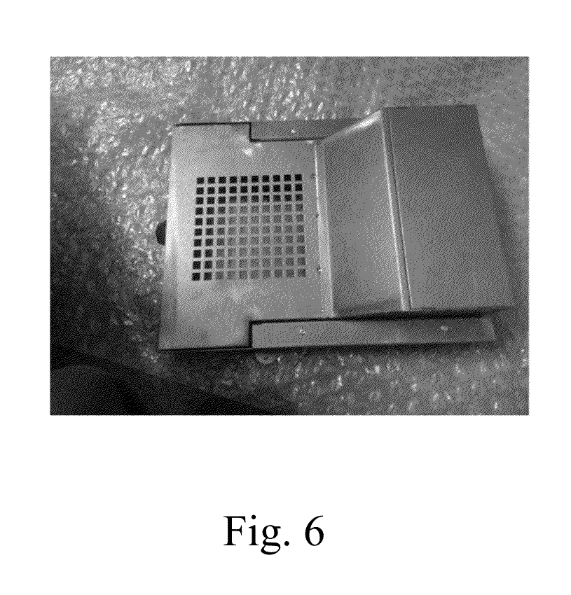

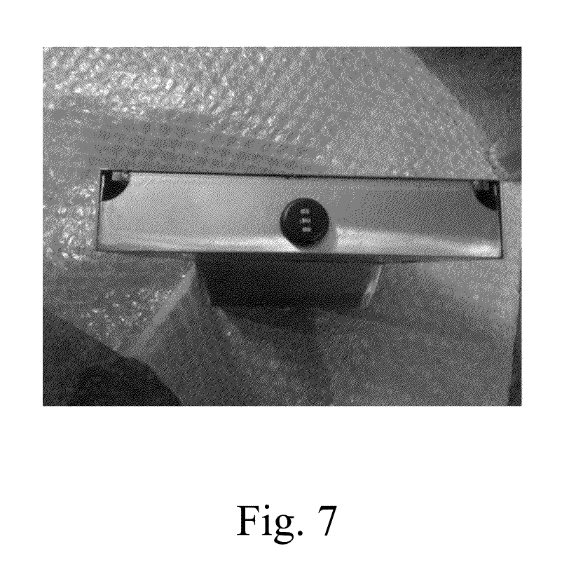

Inclined trough bottom 85 may extend all the way to the rear of the drawer, or may extend to a depth such as two inches below the plane of flat bottom 82 or substantially two inches or more or less than two inches below flat bottom 82, as illustrated in FIGS. 3A-H. Further beyond the inclined portion of trough bottom 85 may be a further flat portion 87 that is parallel or near parallel to the plane of flat bottom 82, such that the further flat bottom 87 extends to the rear of the drawer, as also illustrated in FIGS. 3A-H.

With such a trough, the depth of the drawer can be increased while accommodating the body, including the knees, of the person sitting at the desk. At the same time, trough 84 can accommodate the electronic panel, including the charging port, electric plugs or outlets 45a-45c, USB ports and like of electronic panel 40. Trough 84 can also accommodate the wires and other electronics that provide the ohmic connection, ground and/or electronic cables for electronic panel 40. Thus, according to a further advantage of the trough drawer, such electronics, cords, and the like can be provided out of sight and out of harm's way for the user. Smaller electronic devices, such as cellular telephones, may be accommodated inside trough 84, and further such devices may be accommodated inside trough 84 such that larger electronic devices, such as tablets, laptops or netbooks or the like can stored in receiving area 81 on top with or without direct contact with the smaller electronic devices. According to such a configuration, the trough can provide a “double decker” arrangement and thus hold and charge more than one device simultaneously.

In addition, because the surface of panel 40 can be provided at a 45° angle or at a substantially 45° angle or at some other angle other than perpendicular to the plane of flat bottom 82 of the front of the drawer, it may be easier for the user to plug in, to unplug, to charge and to connect with ports for synchronizing the electronic devices stored in the drawer. That is, an ergonomic configuration may be provided to facilitate connection of the electronic devices into the electric outlets and ports of electronic panel 40 and to reduce the likelihood of bending of prongs of electronic device connectors and the like.

Also shown in FIG. 2 is drawer top portion 90 with anchors 91 that can connect to the bottom of a work surface, such as immediately below a desk or another drawer or the like, or may be attached to a table or bureau or the like. Anchors 91 can secure the drawer to the bottom of the work surface. The drawer itself can then slide in and out of drawer top portion 90.

FIGS. 3A-H illustrate by way of example, dimensions and angles of structures of the drawer with the trough. It will be understood that these dimensions and angles are provided by way of illustration and in no way limit the scope of the present disclosure. Many other dimensions can be provided, and proportions of the drawer can be varied without departing from the spirit of the invention.

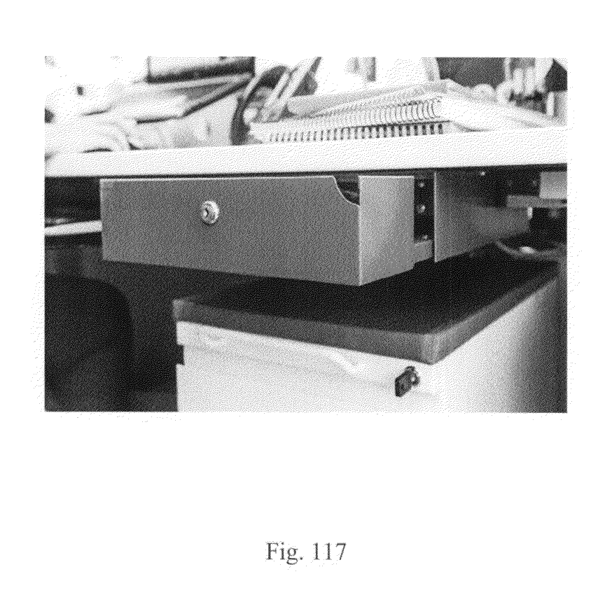

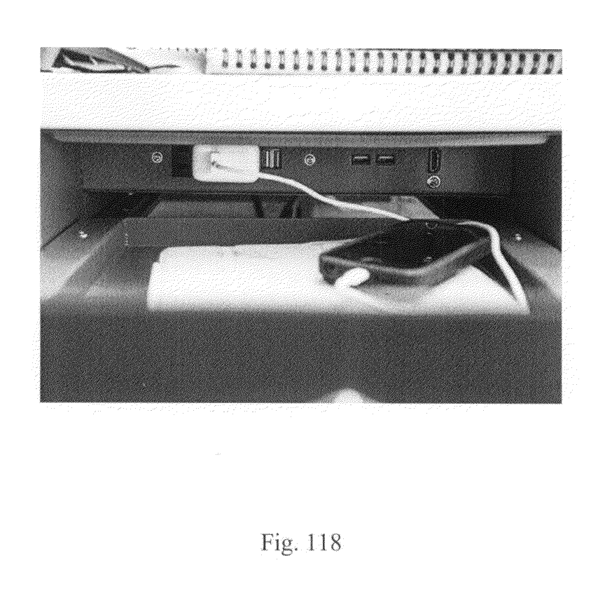

FIG. 14 illustrates drawer with a recess to accommodate a desk support bar.

Often desks or other work surfaces include a support bar provided underneath the desk or other work surface. Mounting a drawer underneath such a work surface would be difficult or impossible because of the presence of the support bar, or mounting a drawer that provides clearance for the support bar can take up more space or seem unsightly. According to an aspect of the present disclosure, recess 95 is provided to accommodate the support bar.

FIG. 14 illustrates a drawer with walls 96 that define recess 95 to accommodate the support bar (not illustrated). Walls 96 may be provided below, immediately rearward and immediately forward of the support bar, and may be integrally formed as a single piece. Walls 96 may also be provided as curvilinear, and the walls may be provided as a single curvilinear, semi-cylindrical or substantially or partially semi-cylindrical wall. Such a single curvilinear wall may also be referred to as walls defining the recess.

Immediately in front of walls 96 that define the recess is a receiving area 81 extending toward the front of the drawer. Receiving area 81 may accommodate electronic devices to be stored in the drawer and charged/synchronized. The front of the drawer in FIG. 14 is illustrated as having an aperture and may receive a lock for a key. Immediately forward of walls 96 that define recess 95 may be provided electronic panel 40, including electronic outlets 45a-45c, USB ports, and other charging and/or synchronization ports. Receiving area 81 may extend beneath and past walls 96 defining recess 95. Accordingly, larger electronic devices, such as laptops, netbooks, tablets, and the like, can be easily accommodated and stored inside receiving area 81 of the drawer. According to such a configuration, electronic panel may be positioned above this portion of receiving area to allow such larger electronic devices to be inserted.

Also described is a drawer that may be installed vertically, such that a shorter side of the drawer is mounted immediately under the desk or other work surface. As illustrated, for example, in FIG. 102, vertically mounted drawer includes top portion 102, which may be a lateral side of the drawer that is less wide than bottom 103 of the drawer. Top portion may be installed under a work surface, for example, so that it is flush therewith. A bottom 103 of vertically mounted drawer may be positioned vertically. Electronic panel 40 may be positioned to align with a panel plane that is substantially perpendicular to bottom 103, so that receiving area 81 extends substantially perpendicular or transverse to the panel plane. Receiving area 81 may extend past electronic panel 40 to accommodate larger electronic devices; according to such an embodiment, a recess is provided between panel 40 and vertical bottom 103.

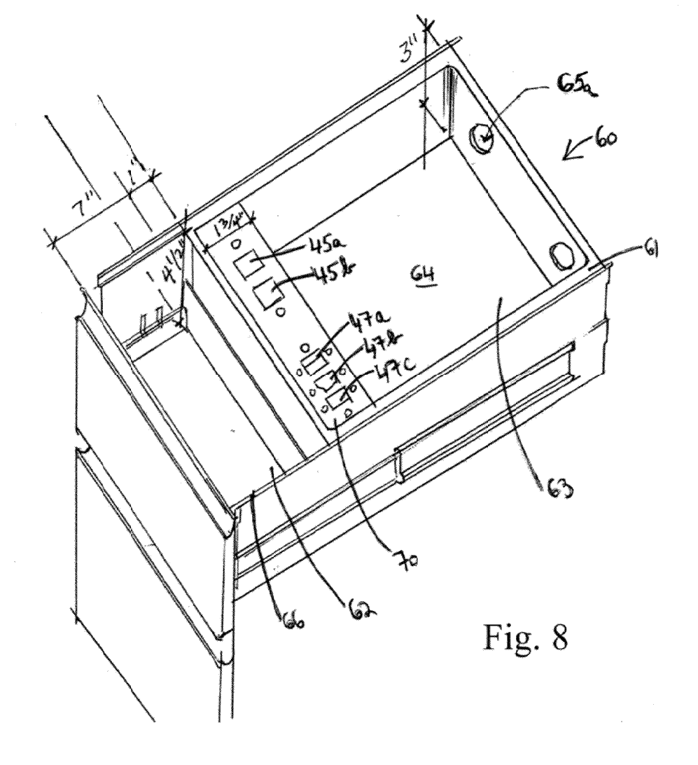

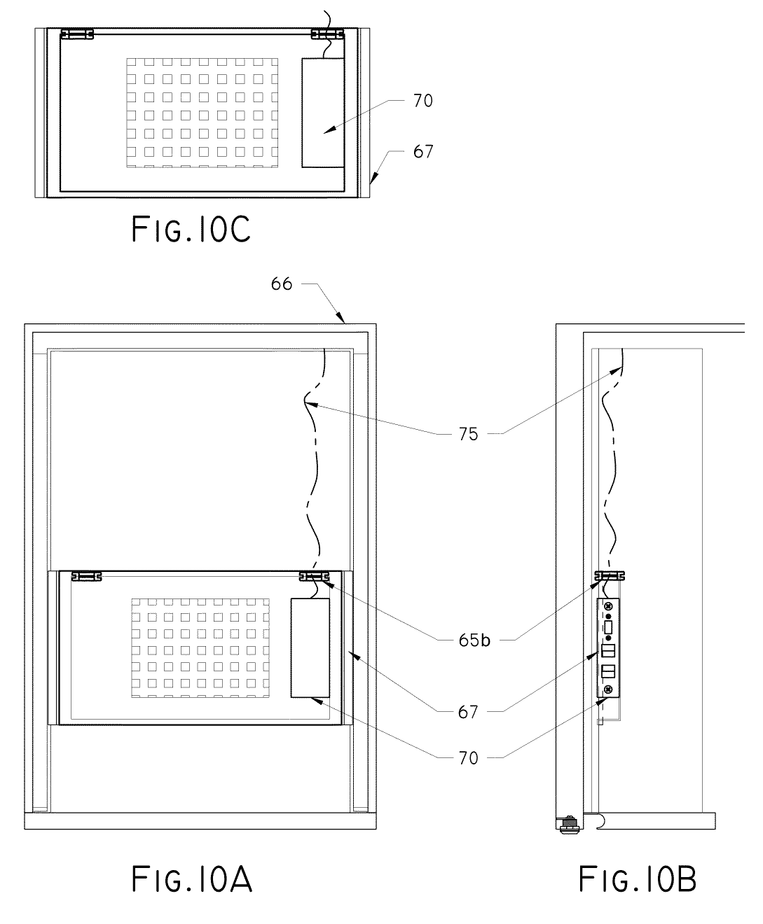

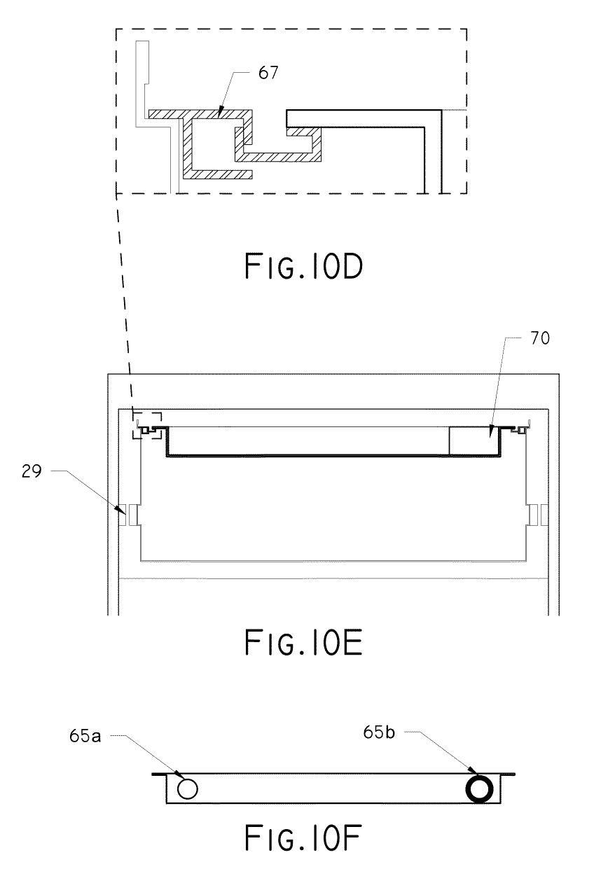

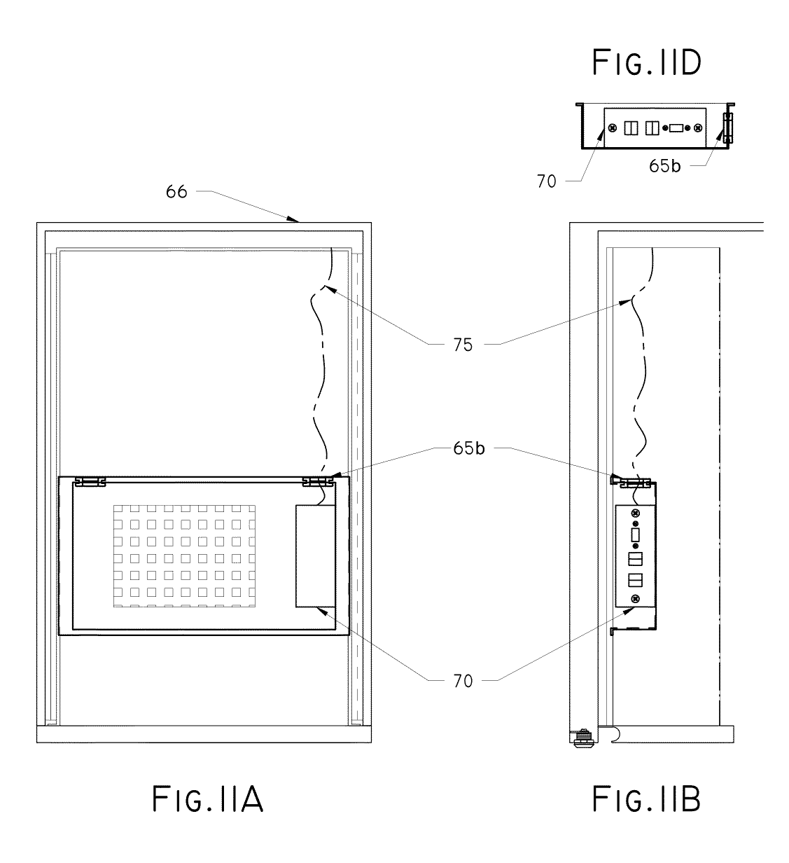

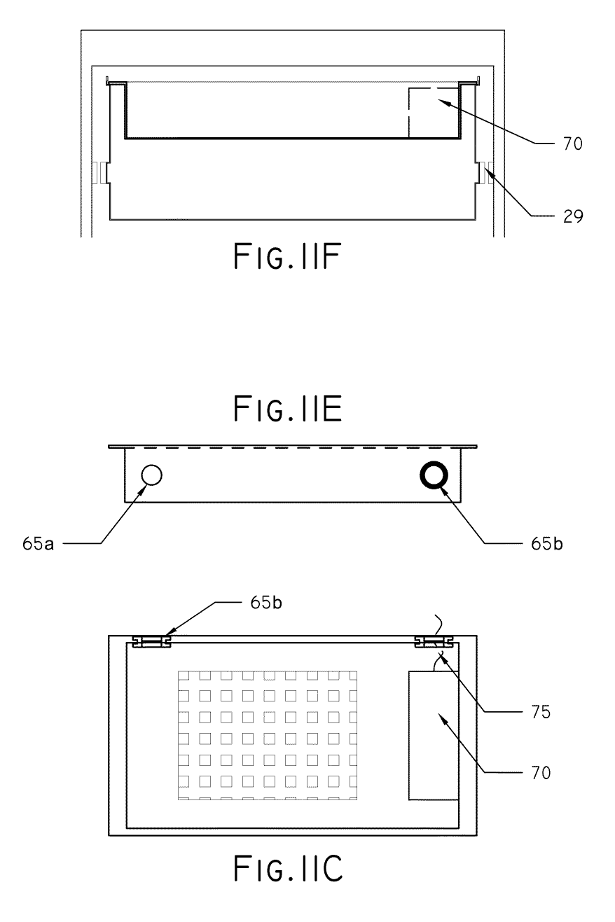

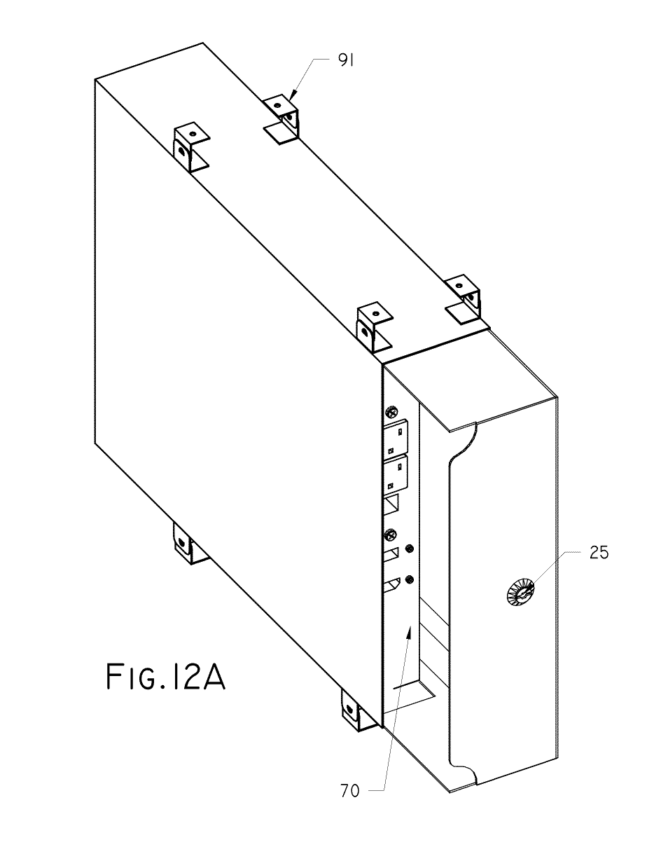

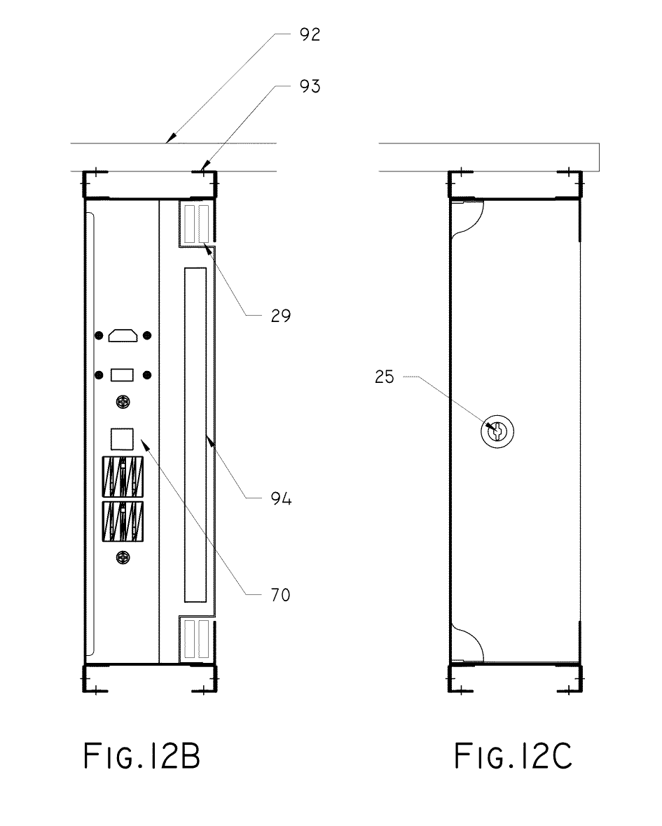

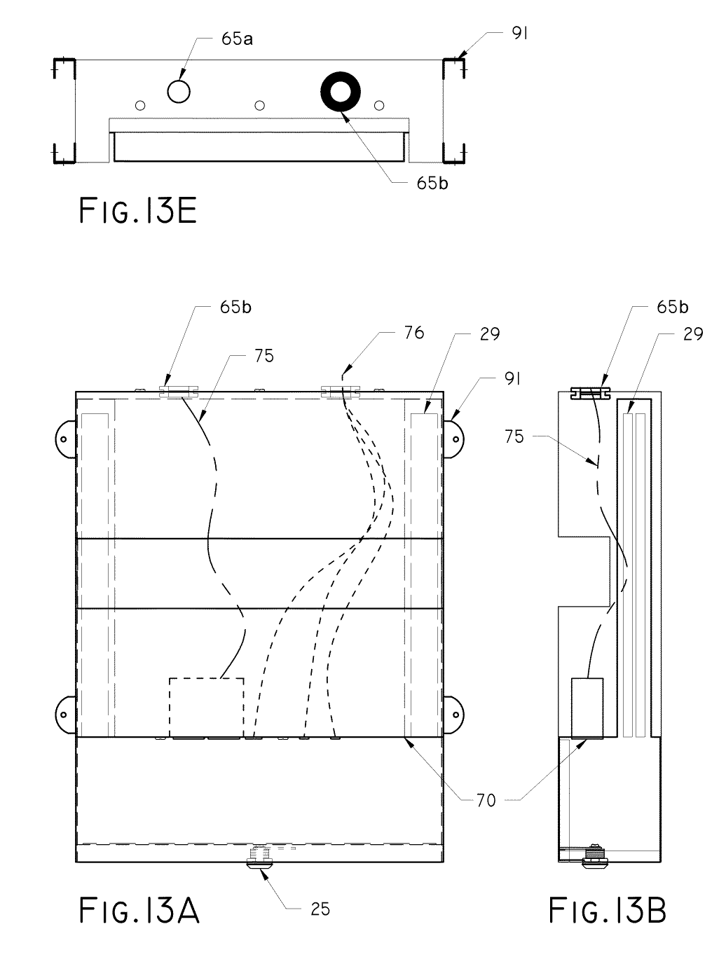

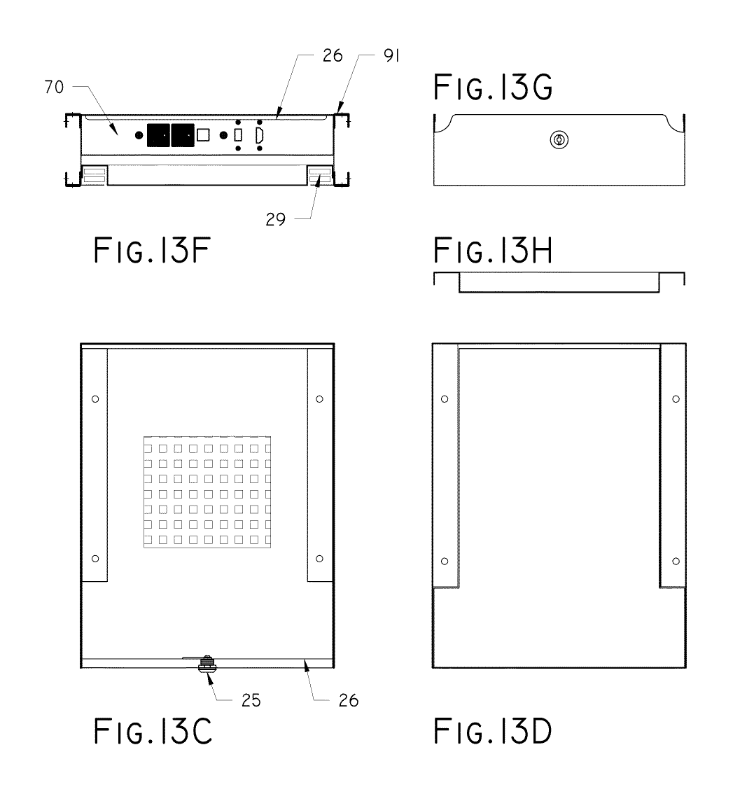

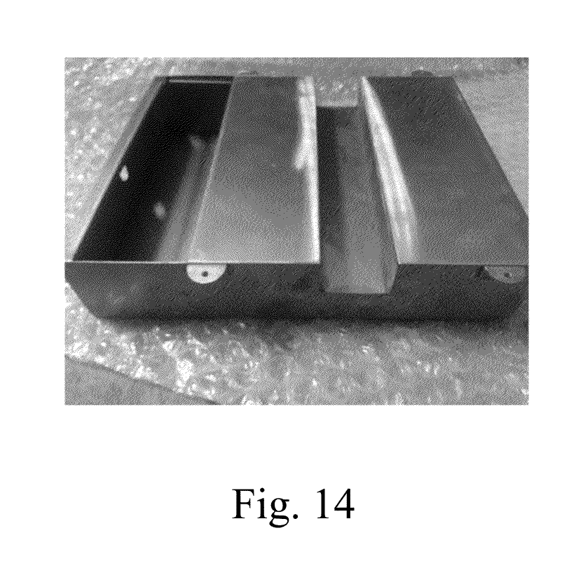

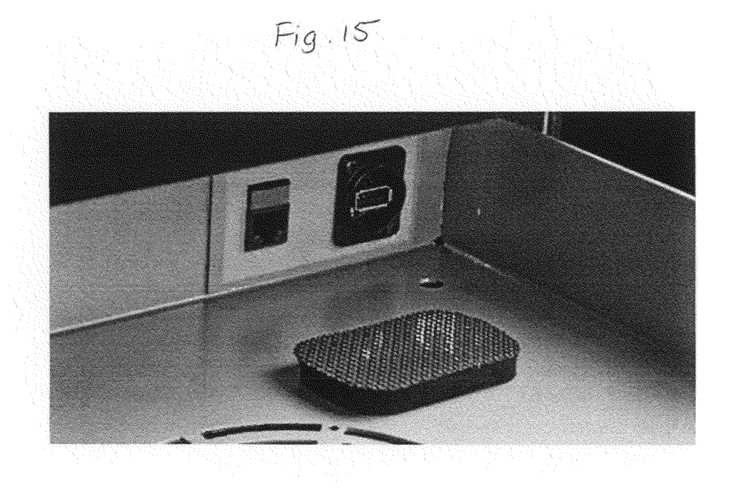

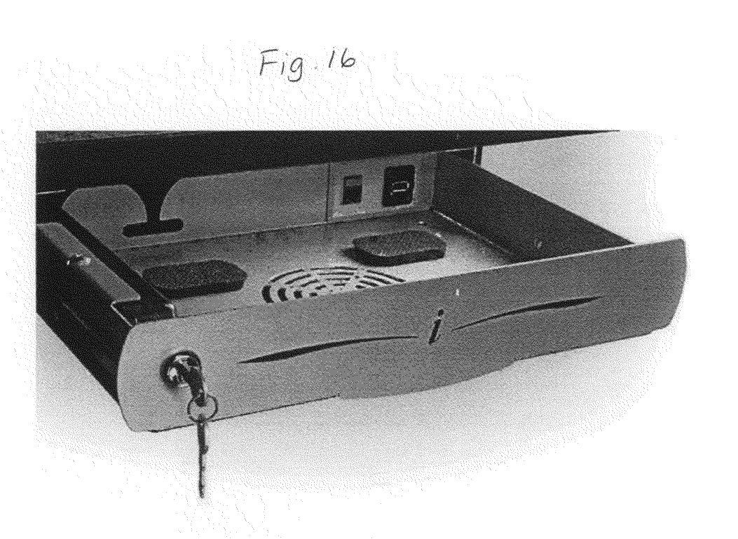

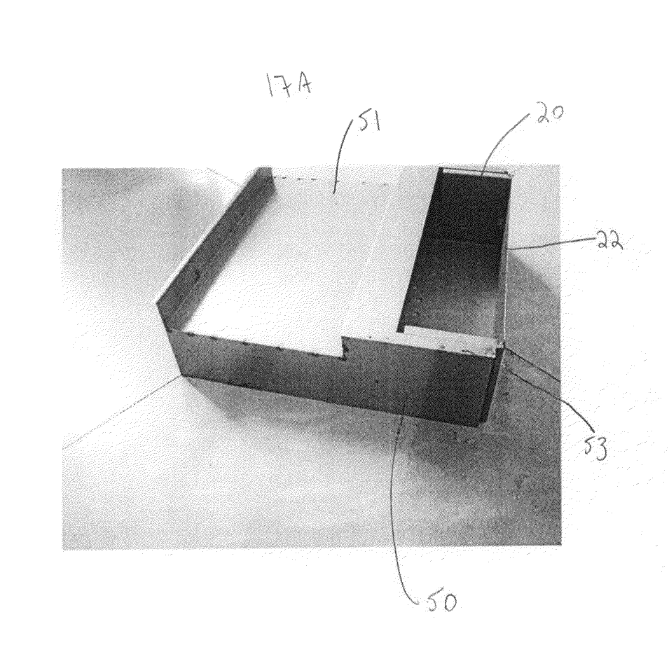

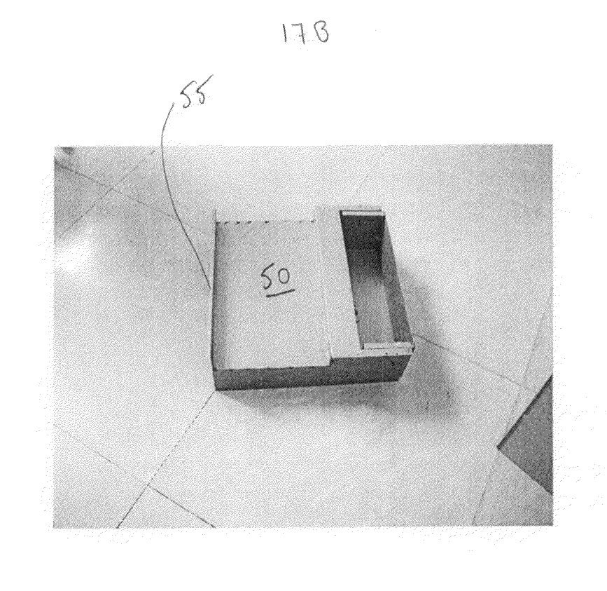

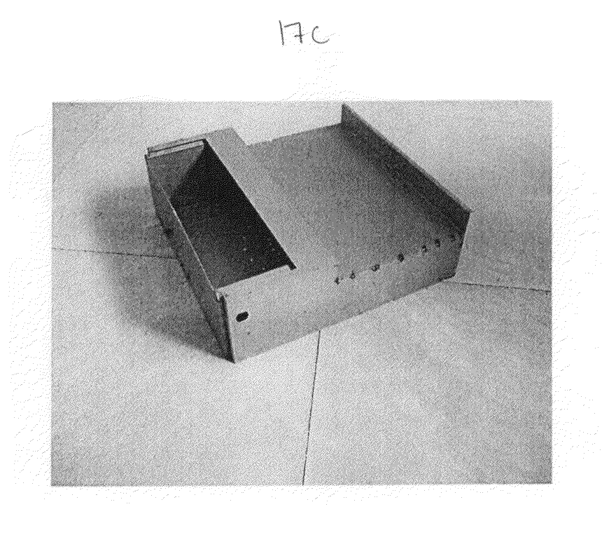

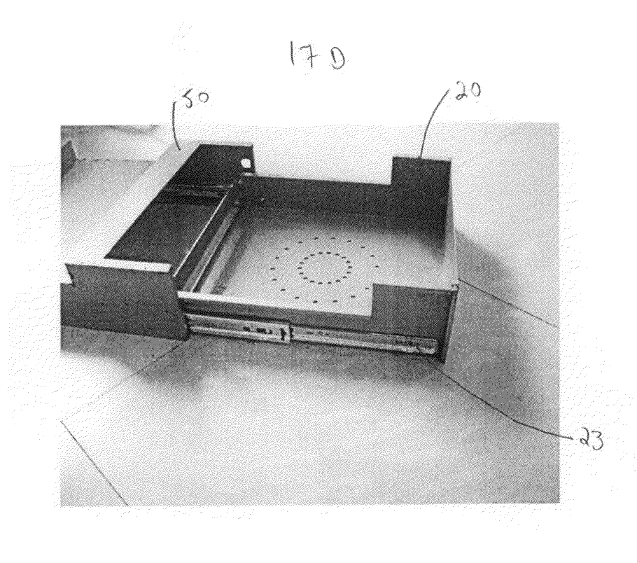

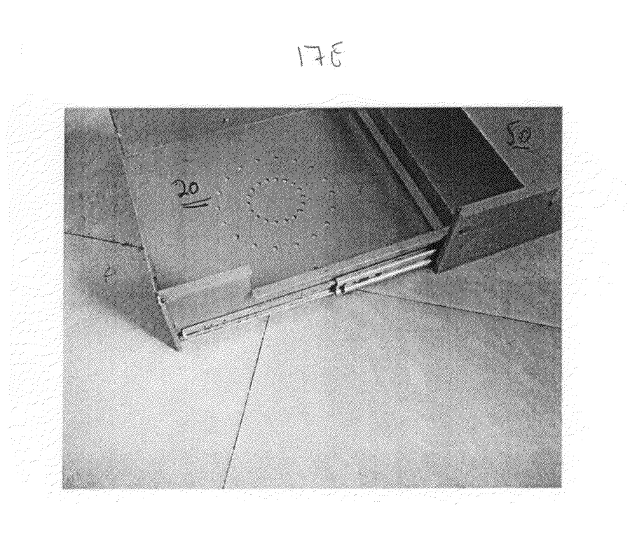

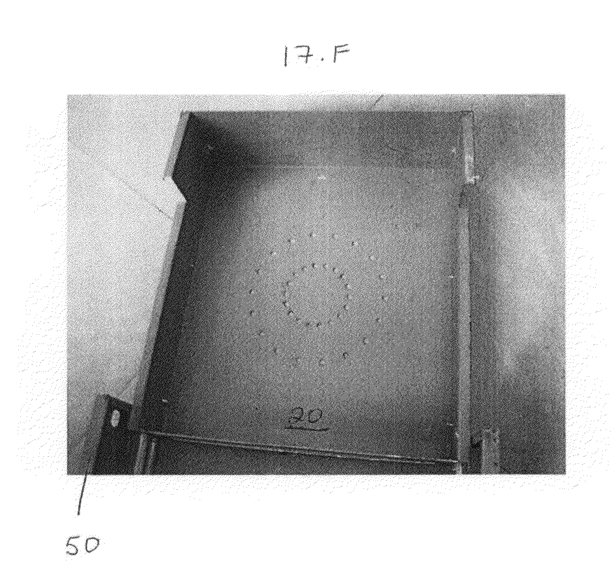

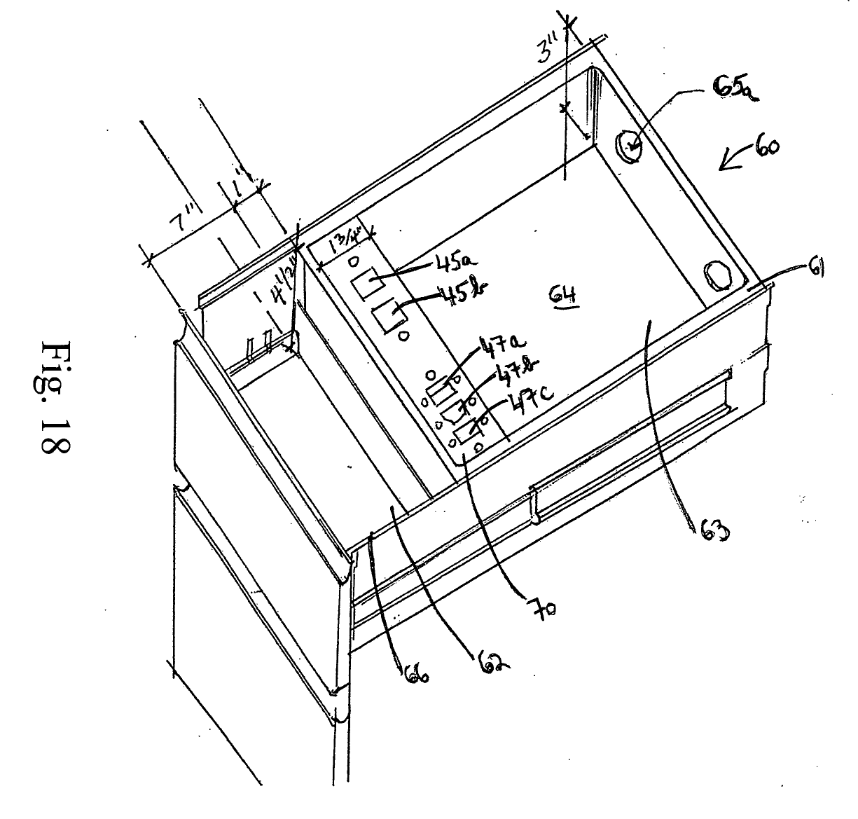

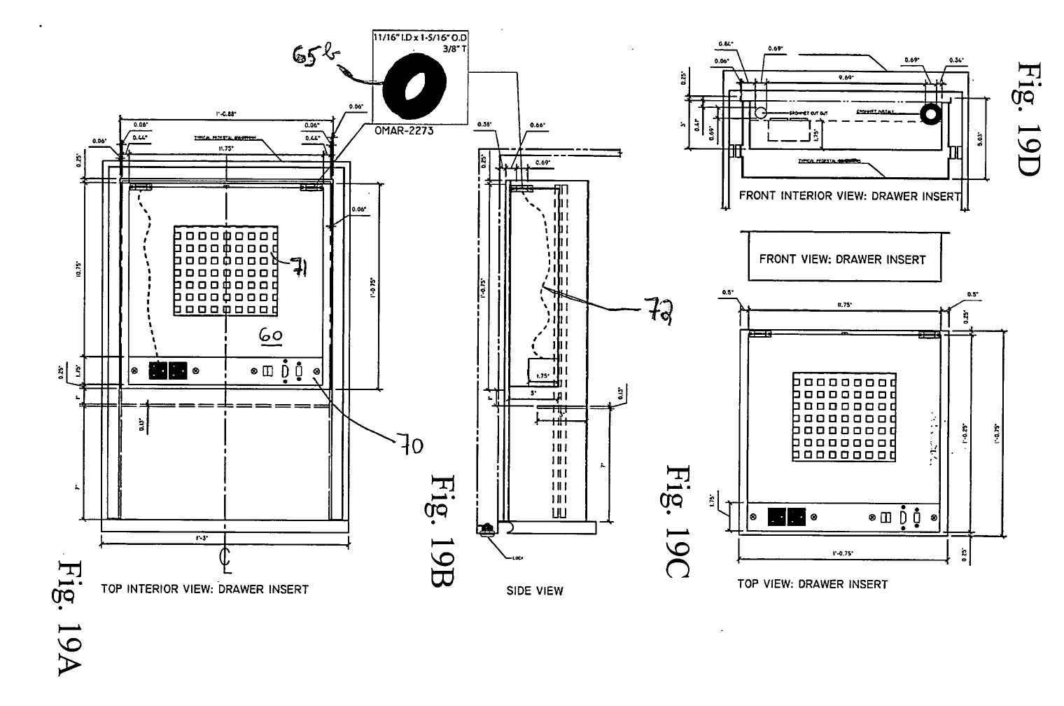

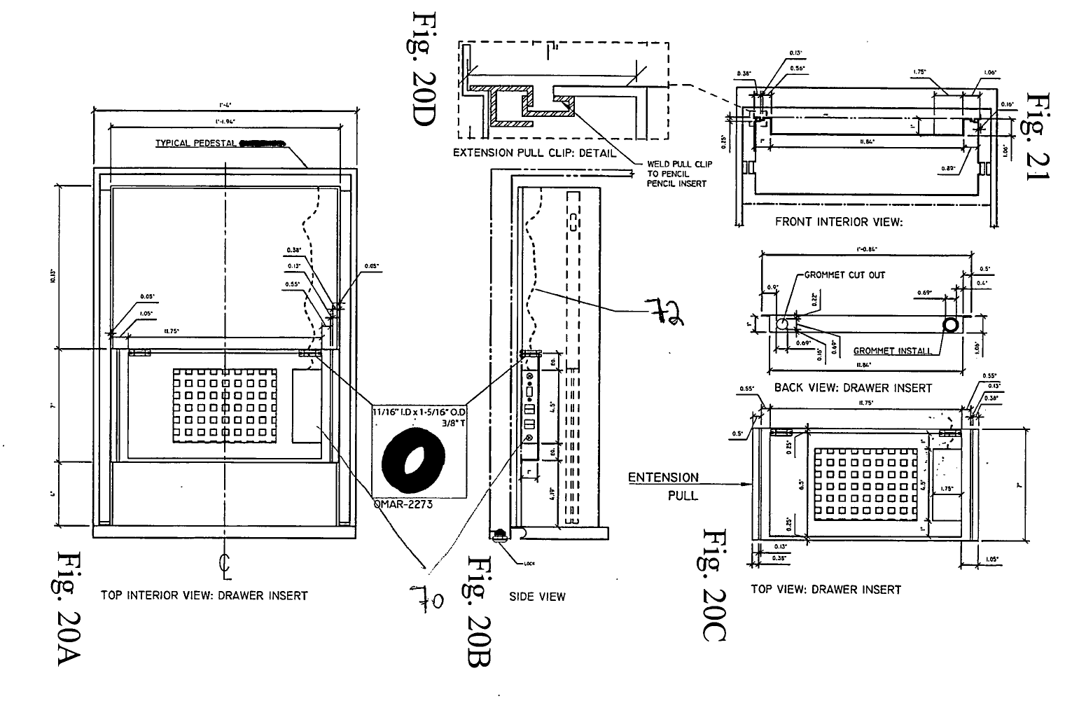

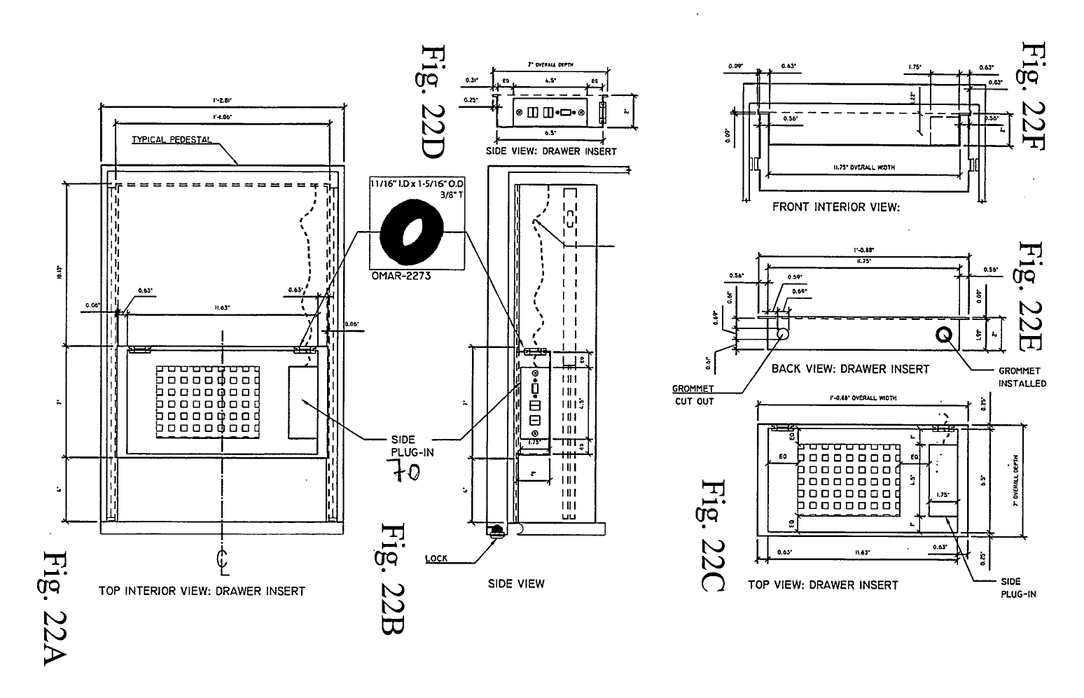

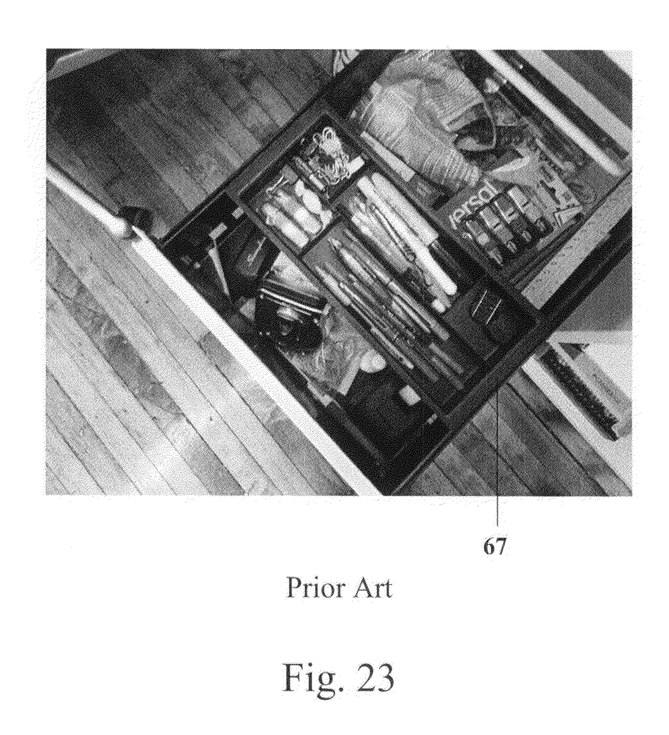

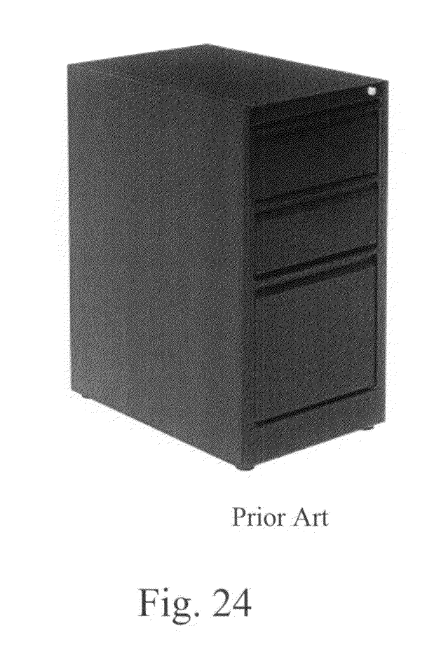

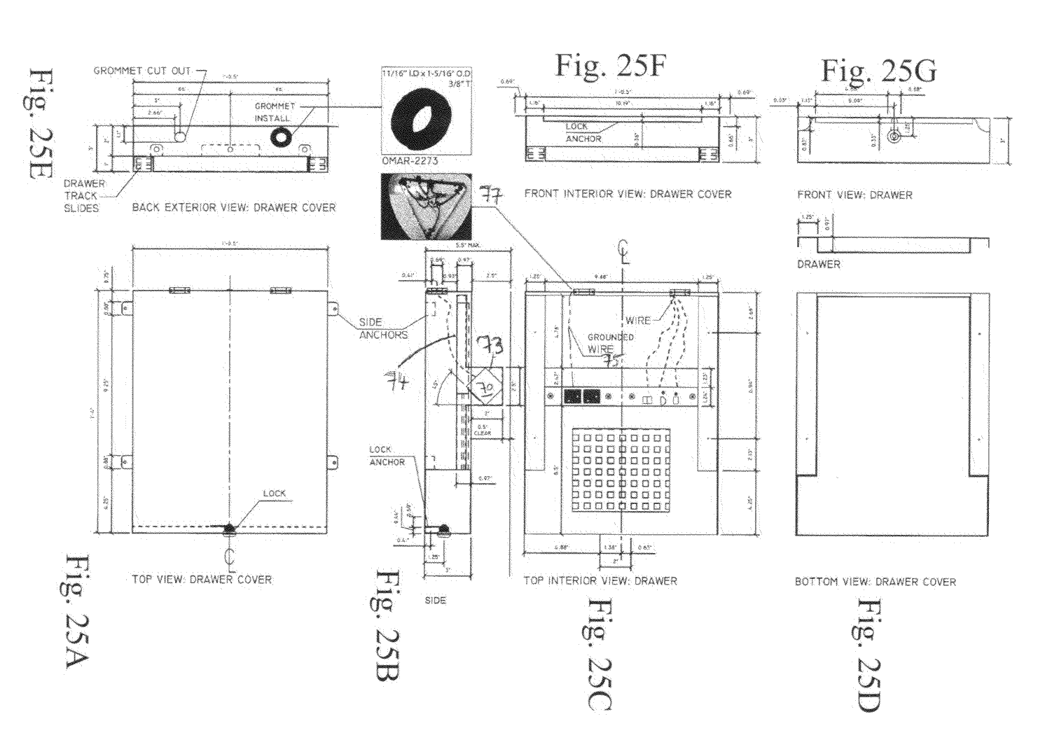

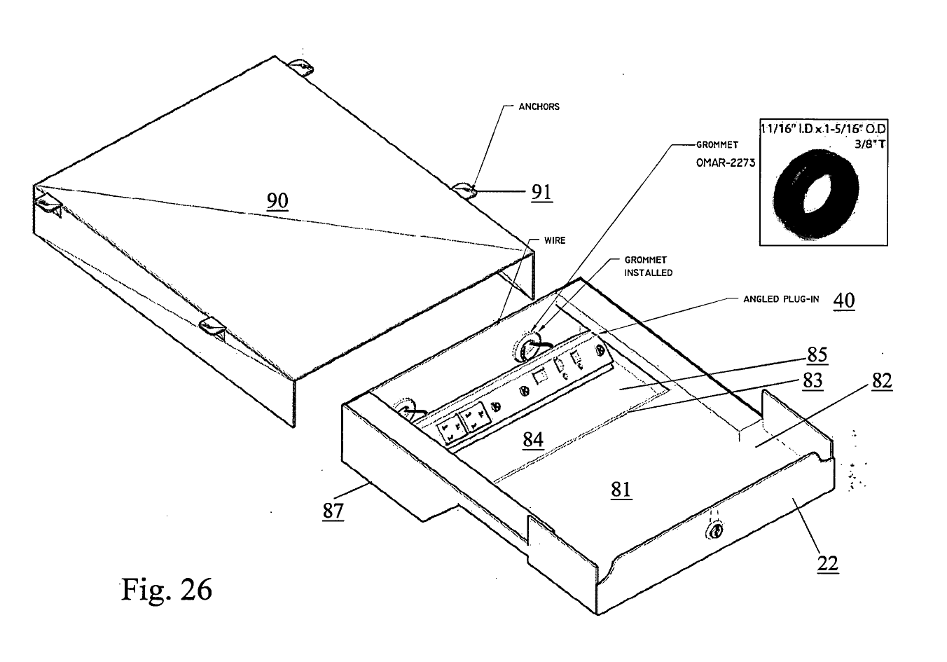

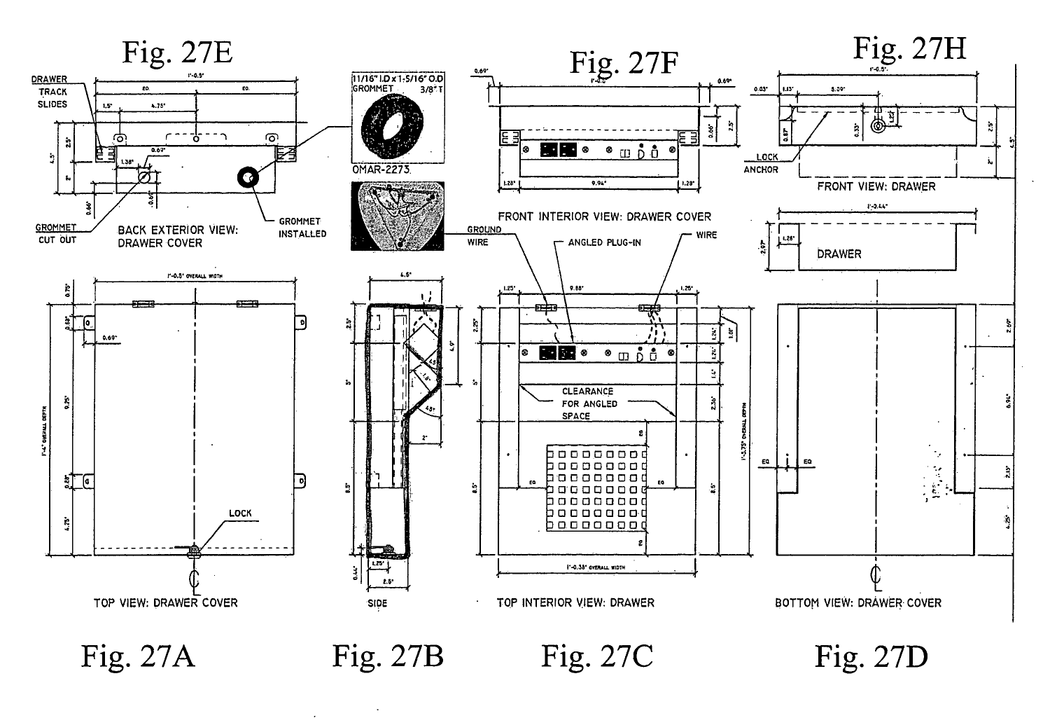

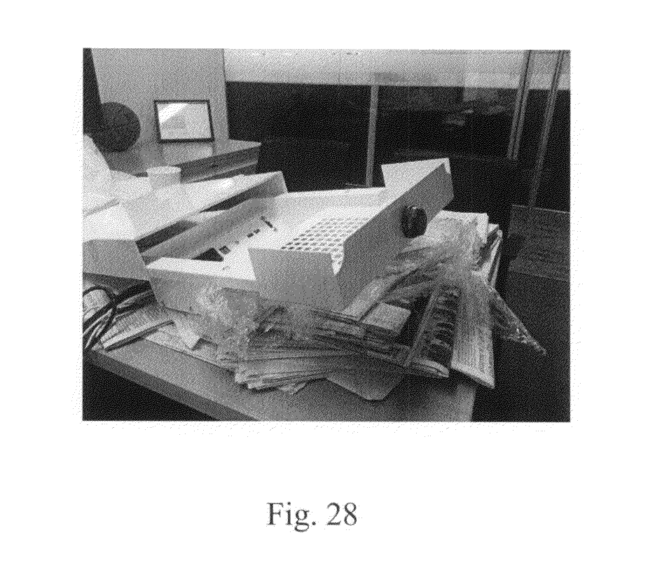

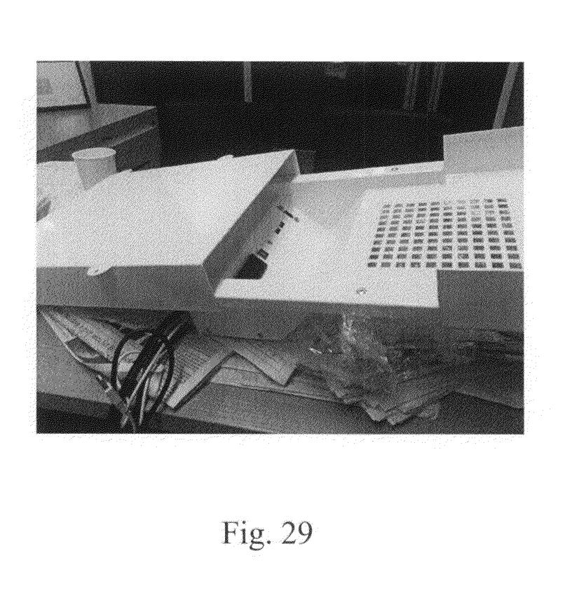

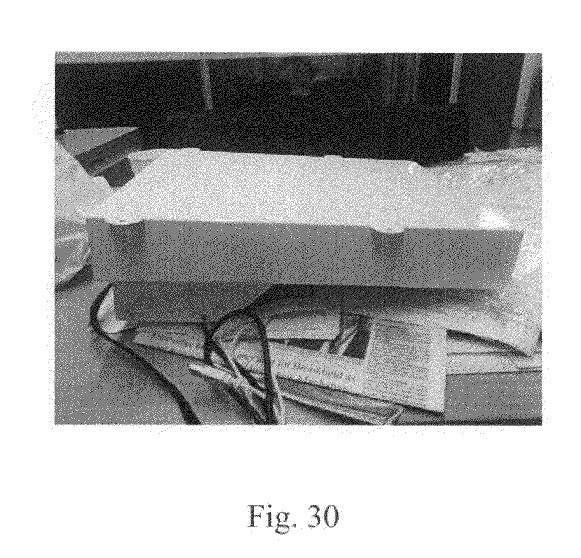

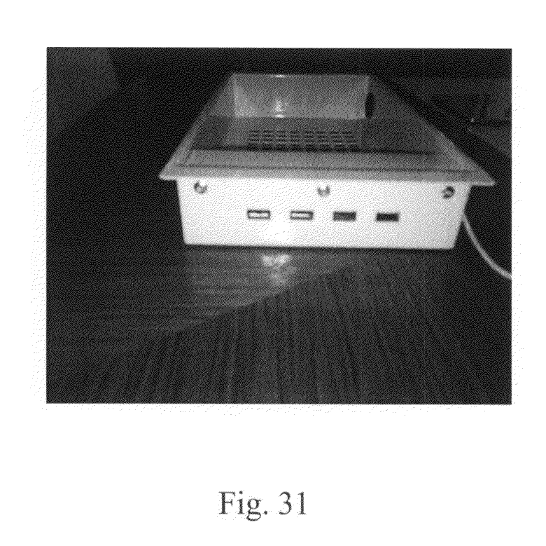

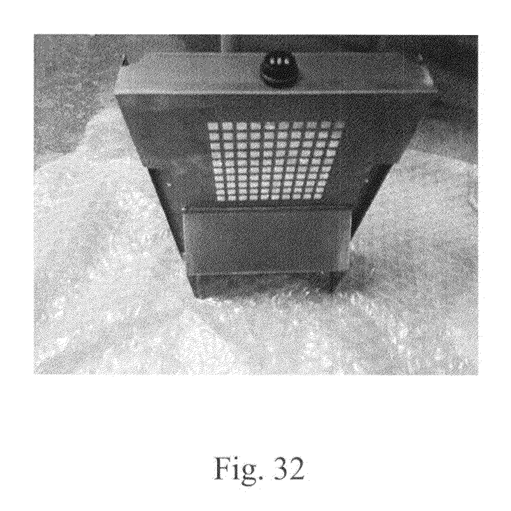

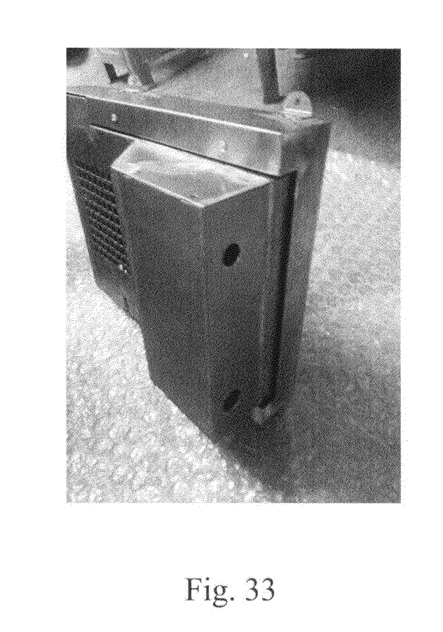

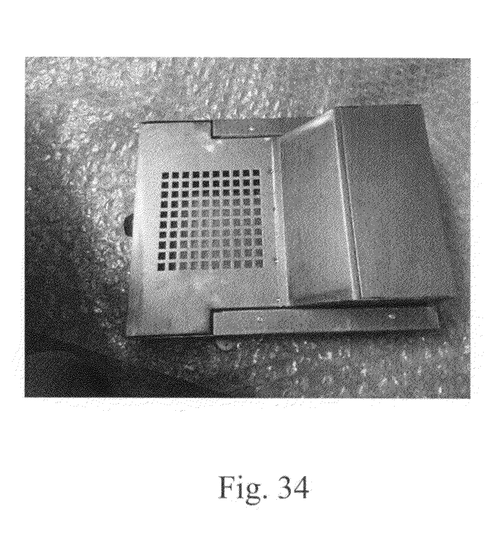

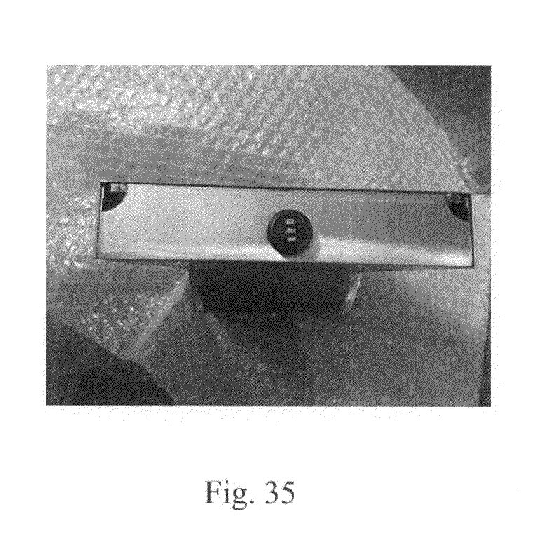

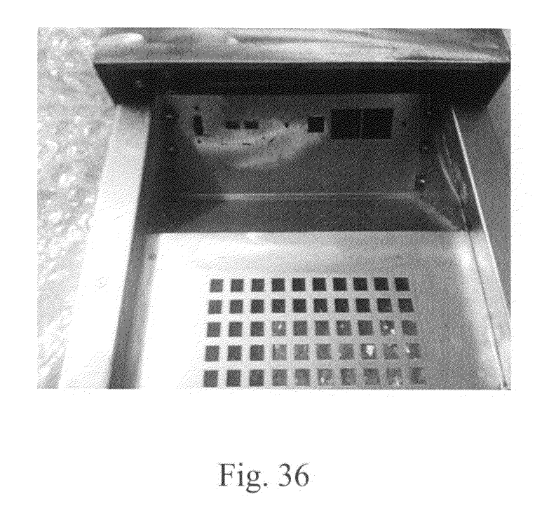

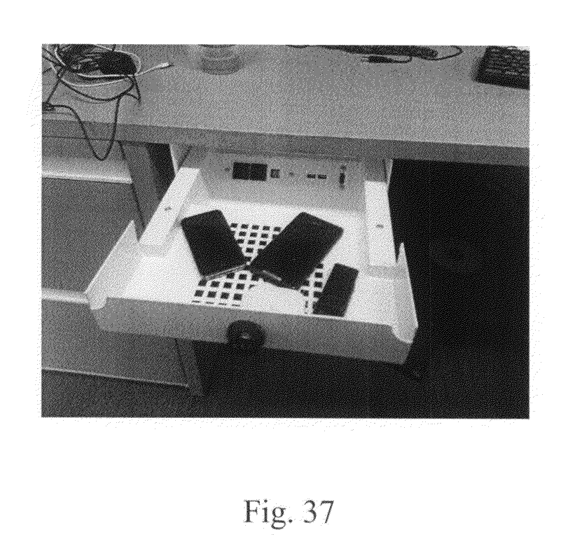

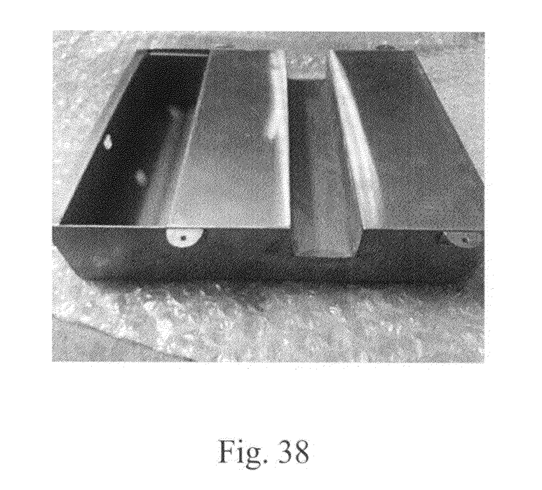

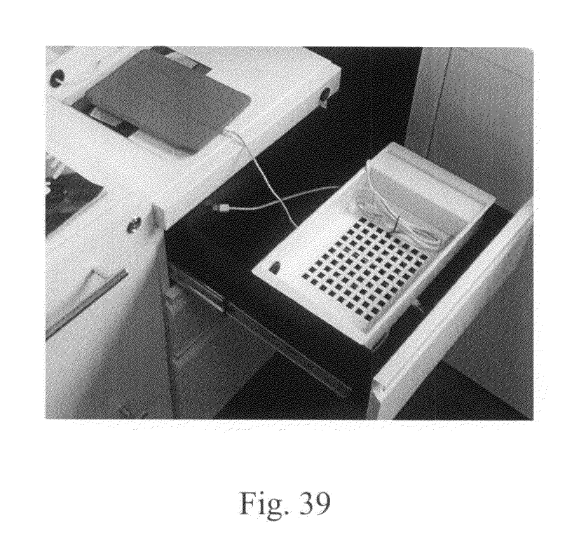

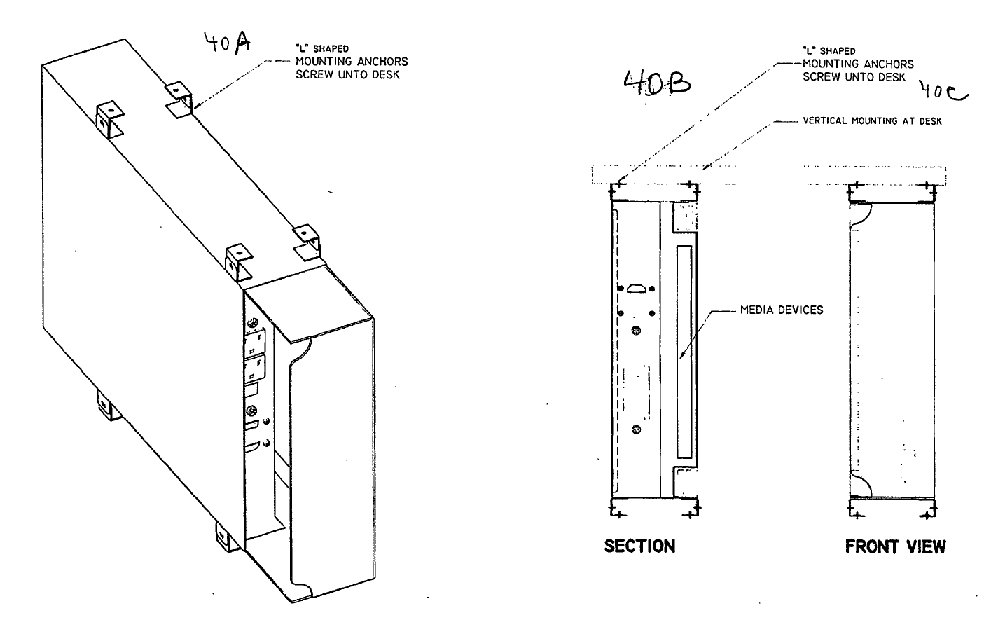

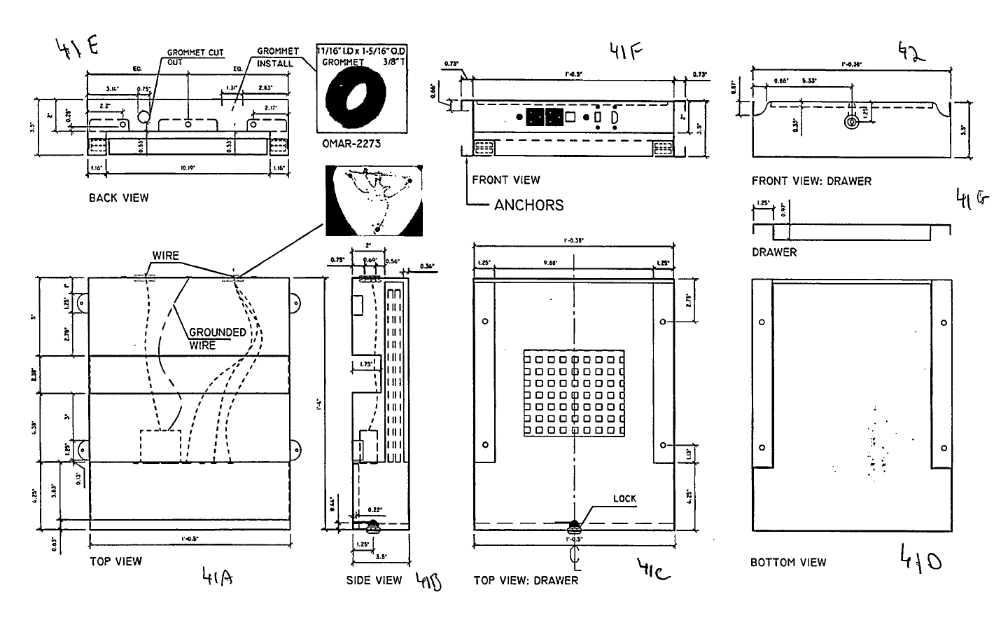

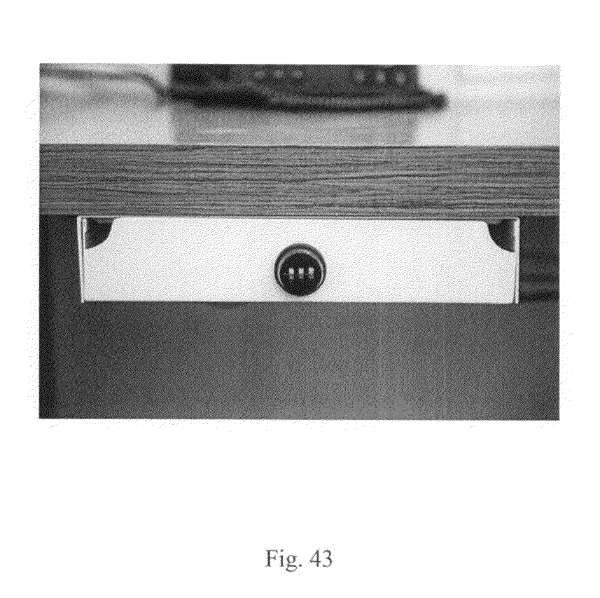

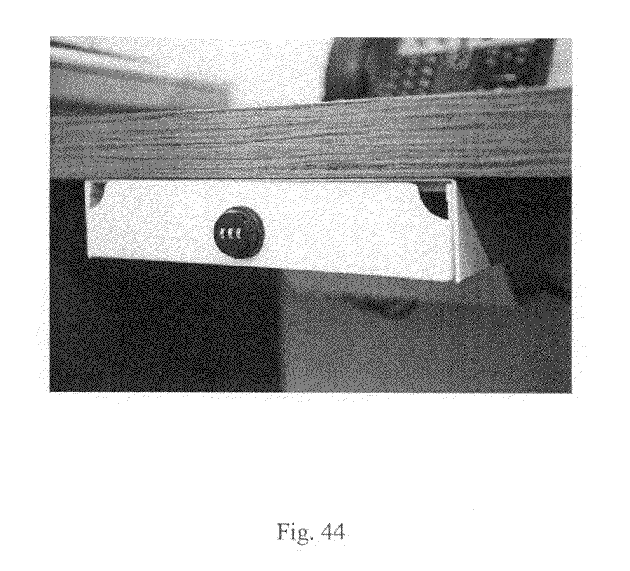

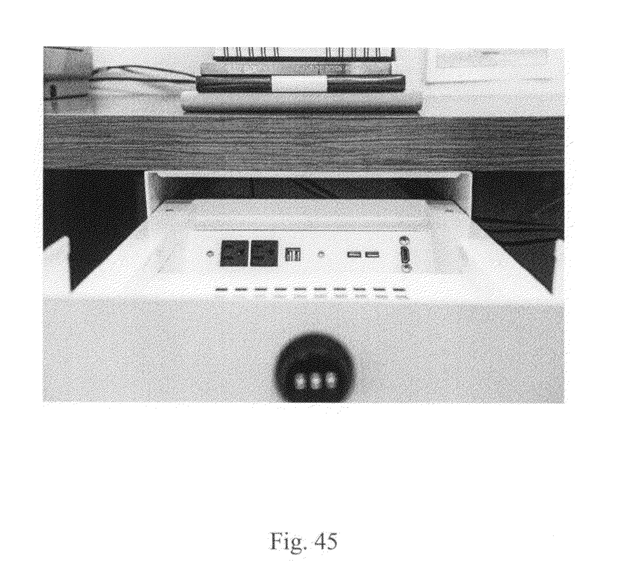

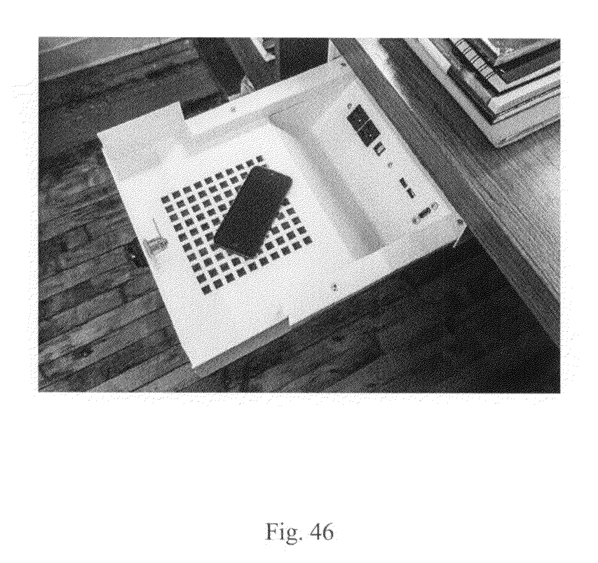

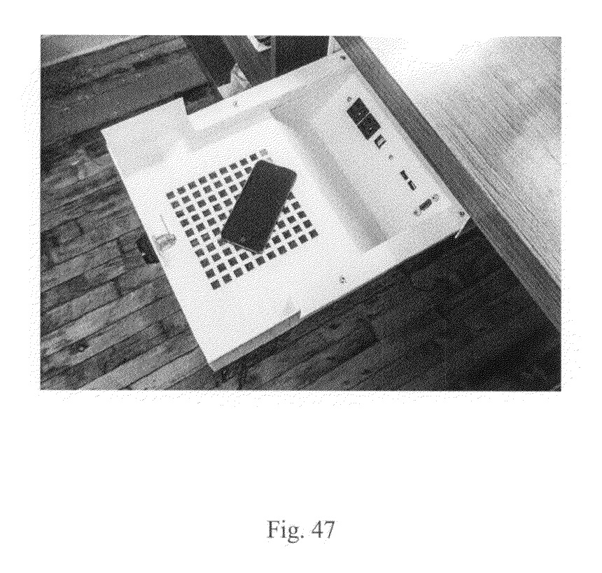

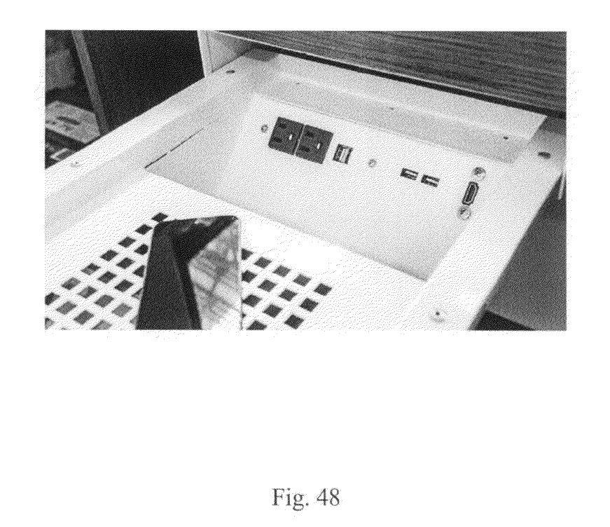

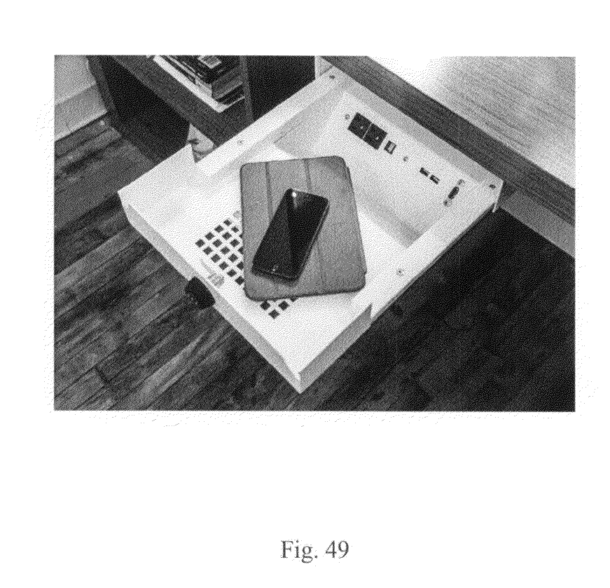

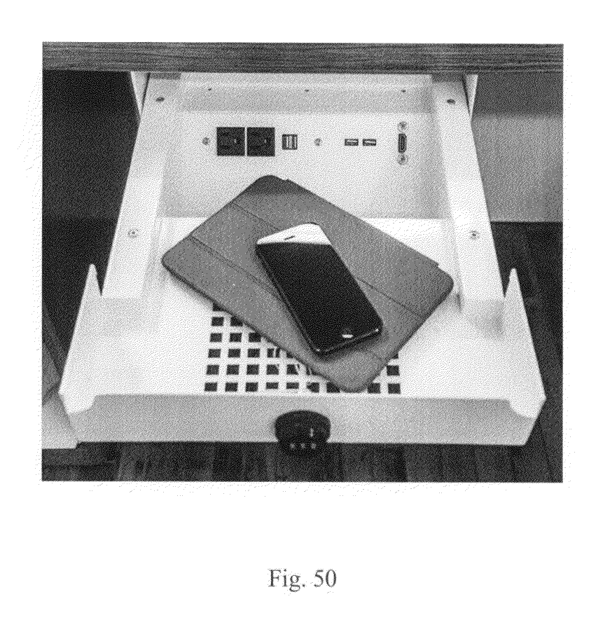

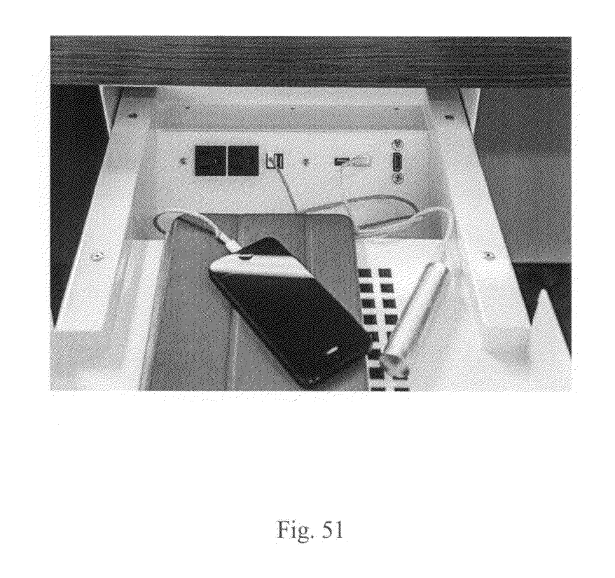

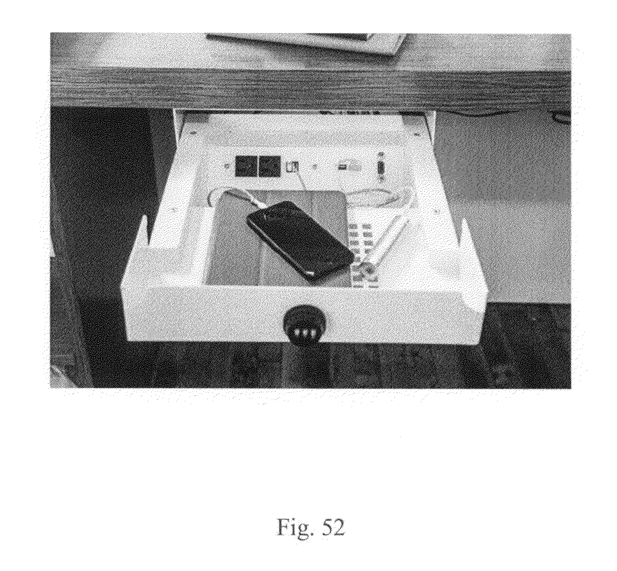

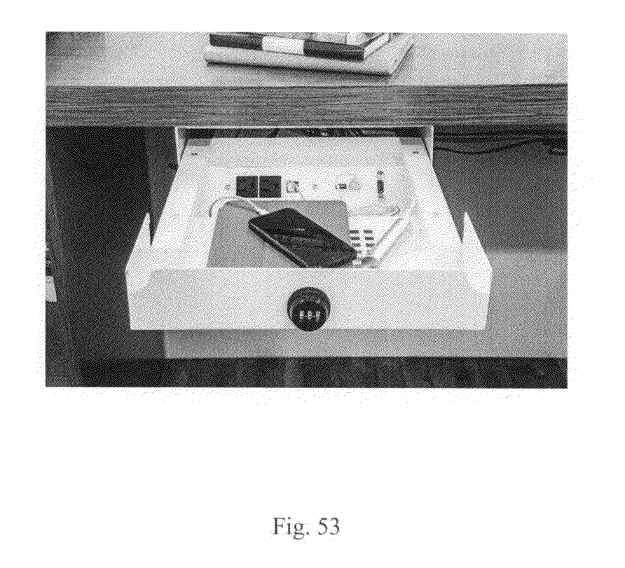

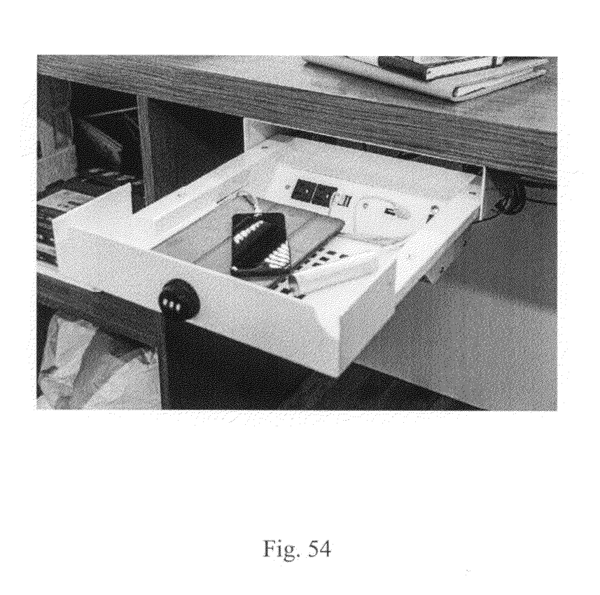

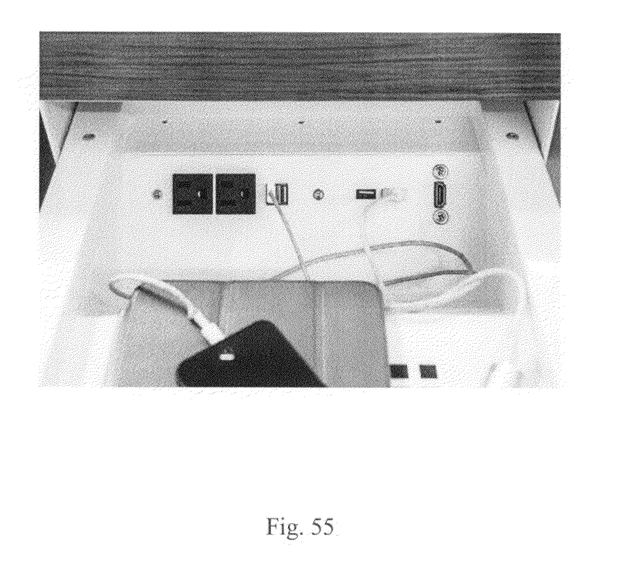

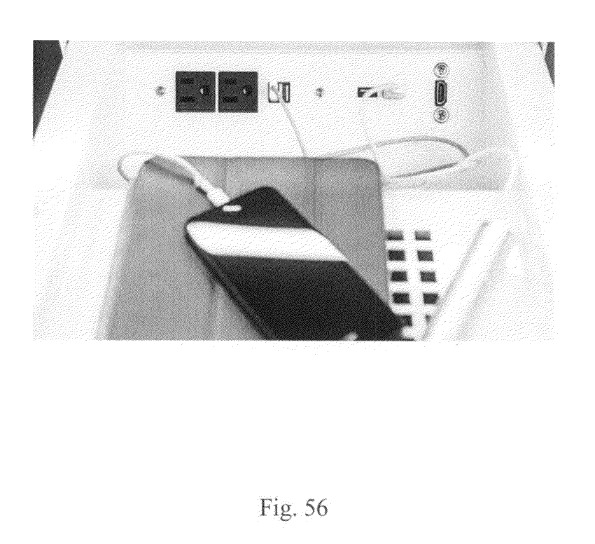

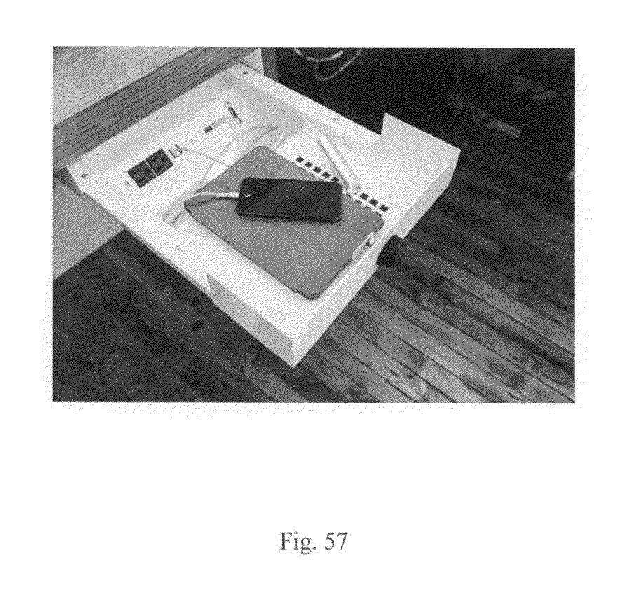

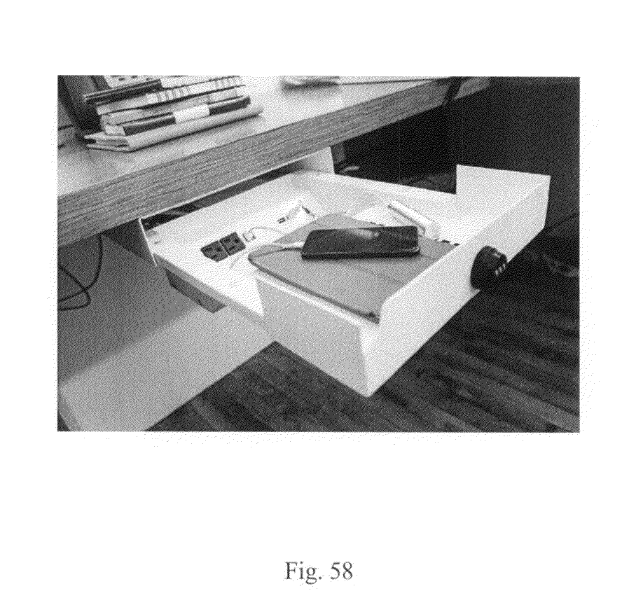

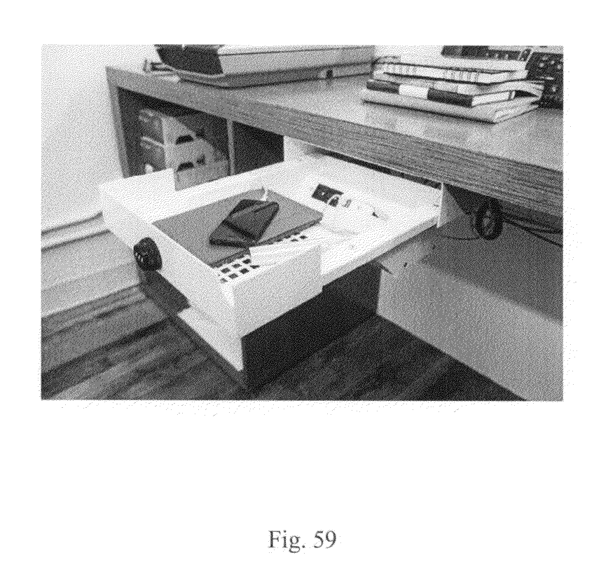

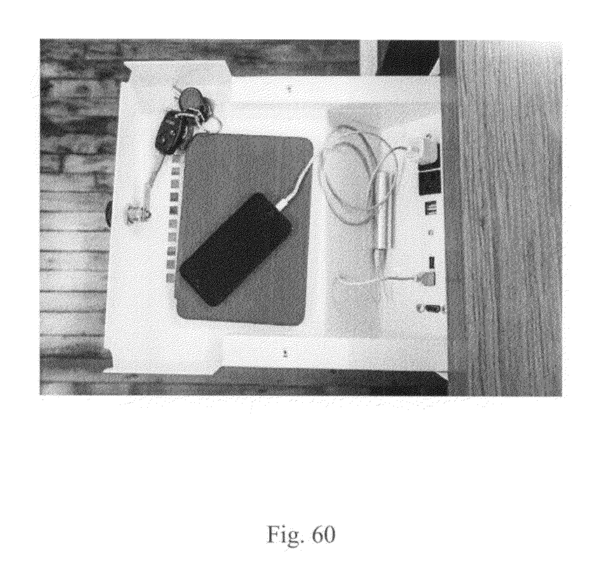

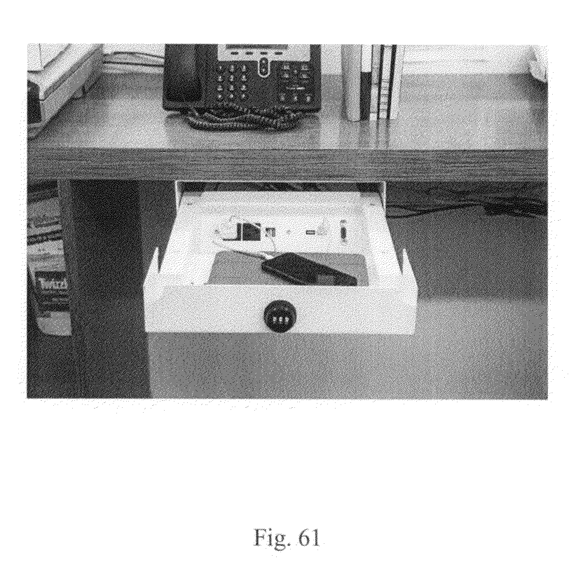

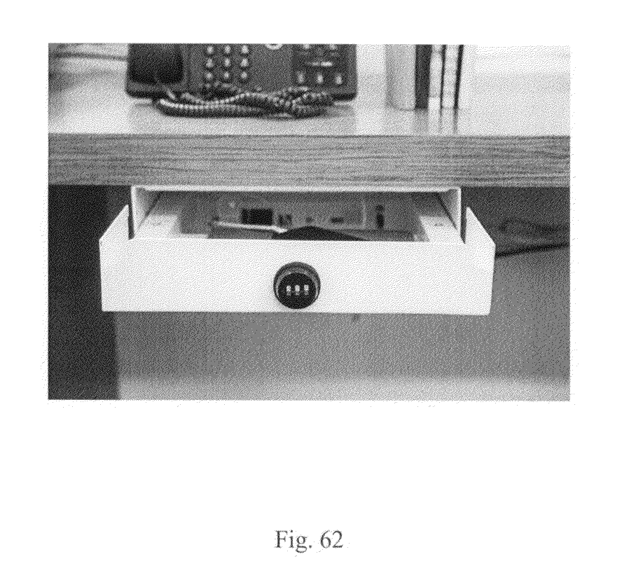

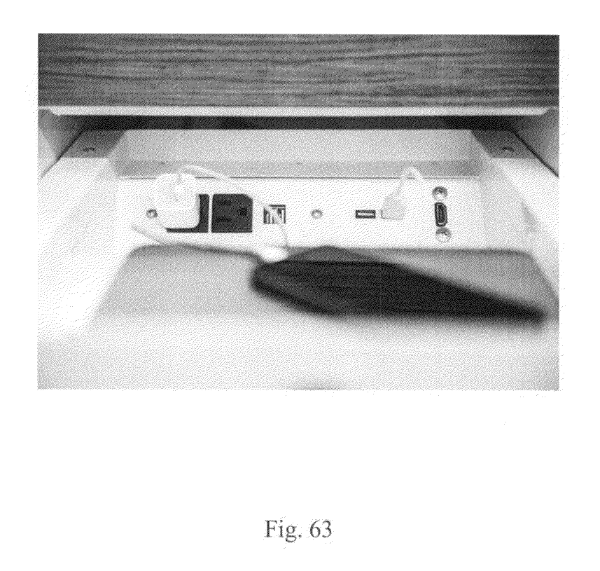

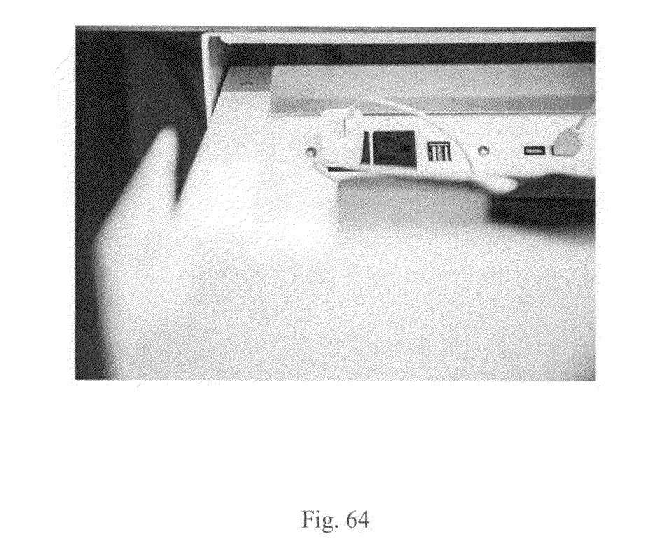

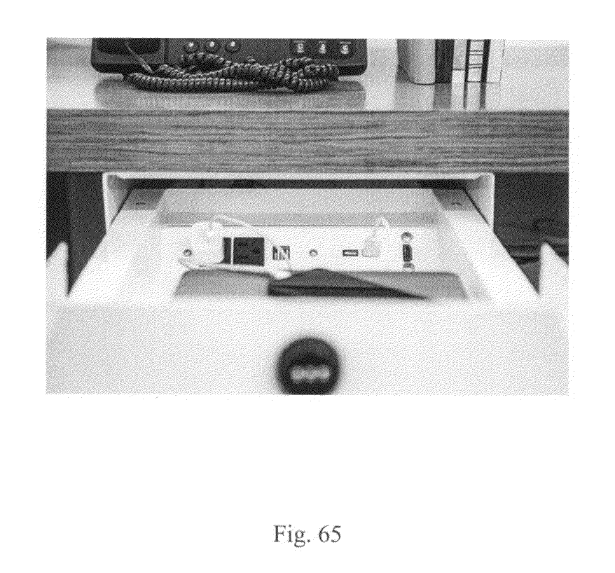

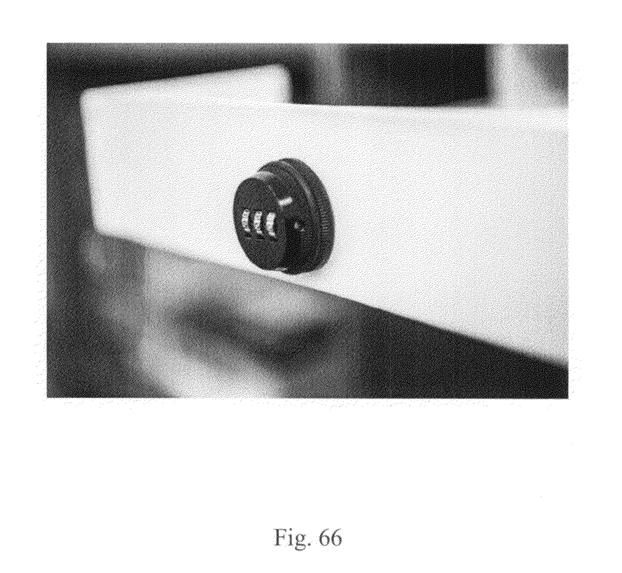

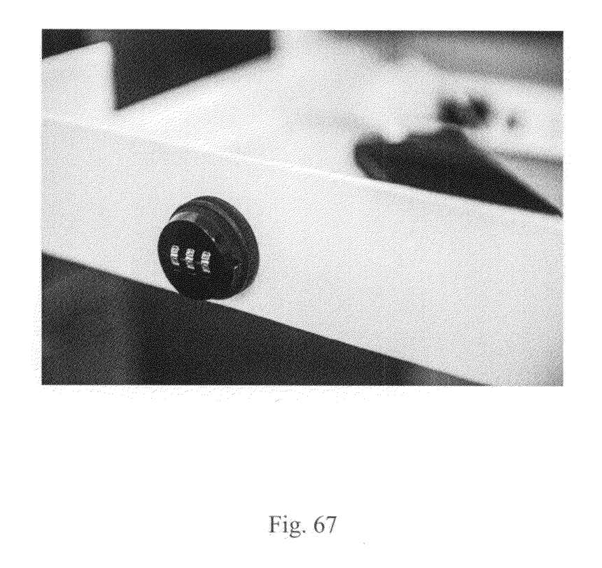

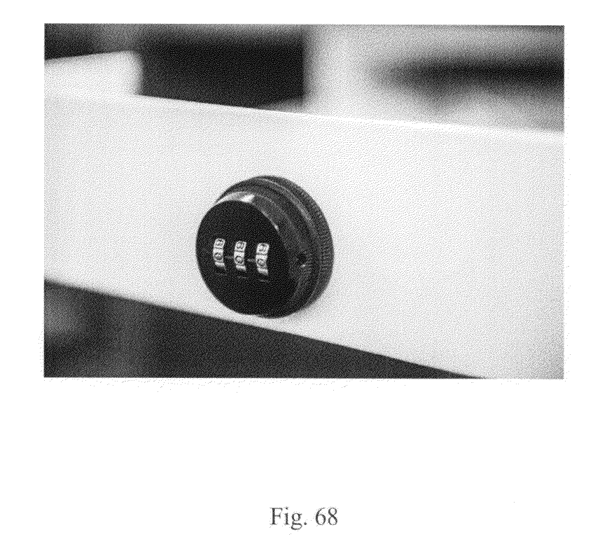

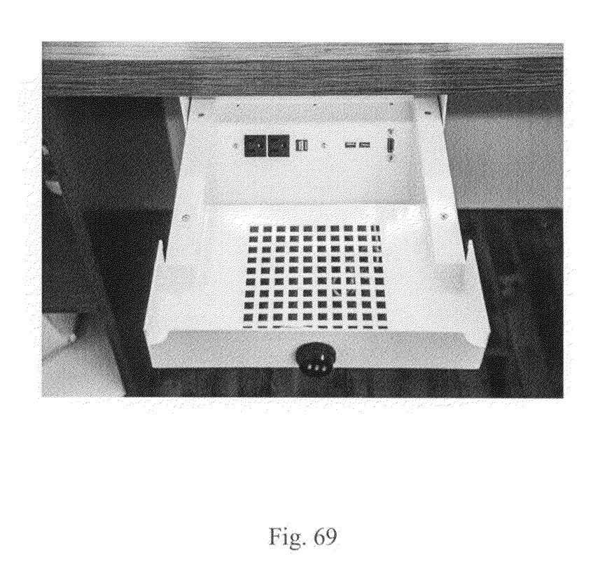

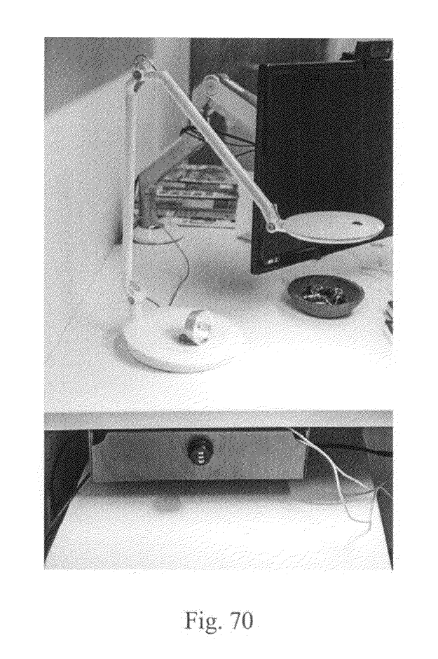

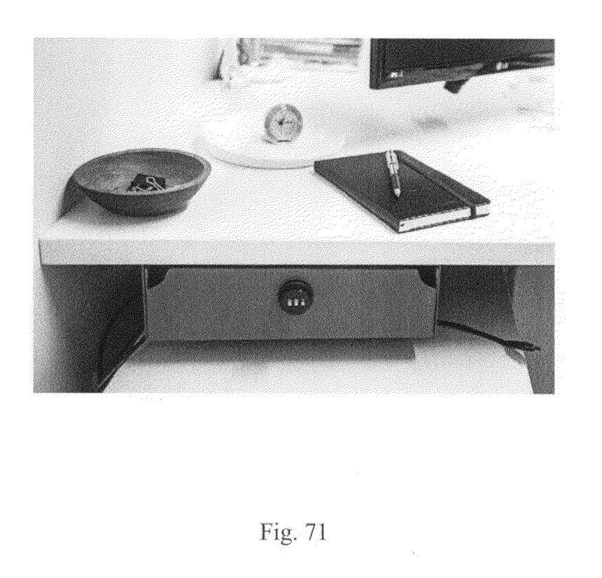

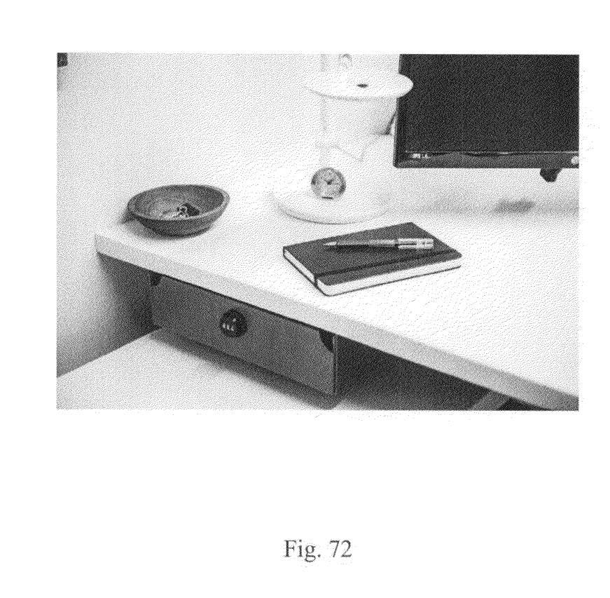

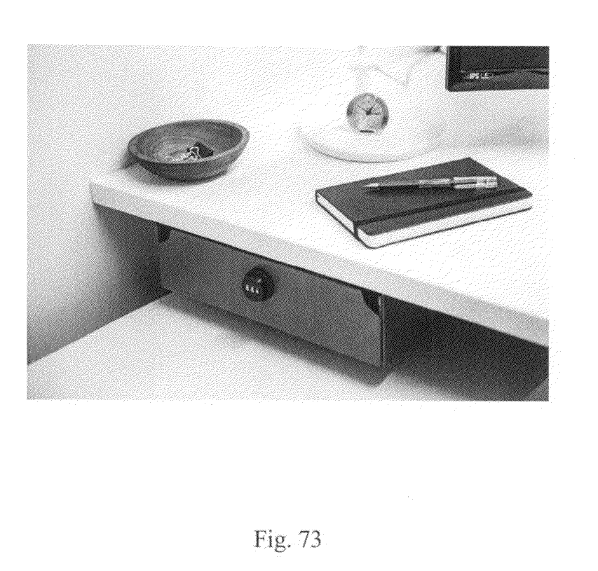

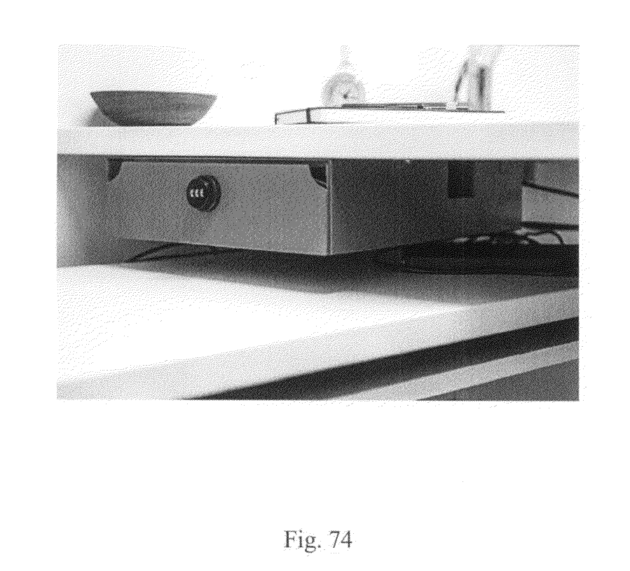

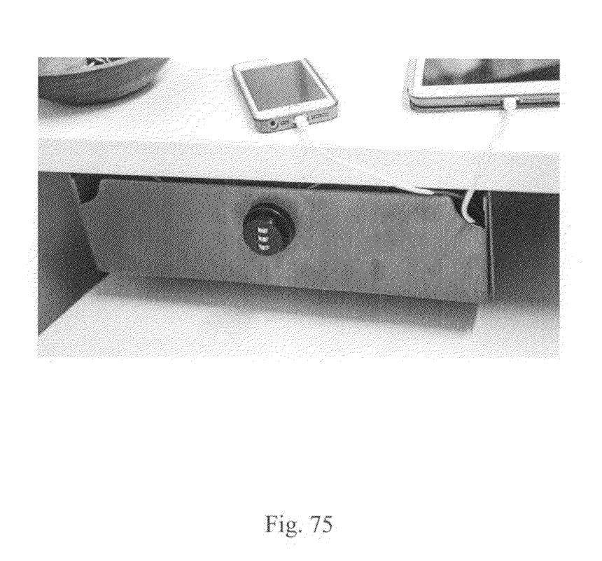

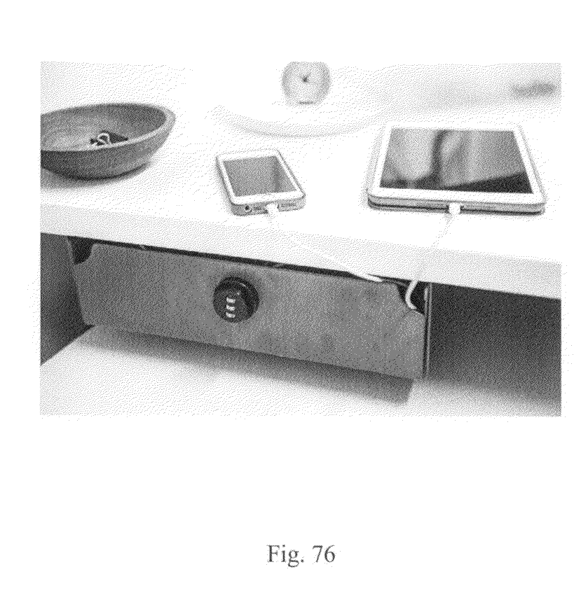

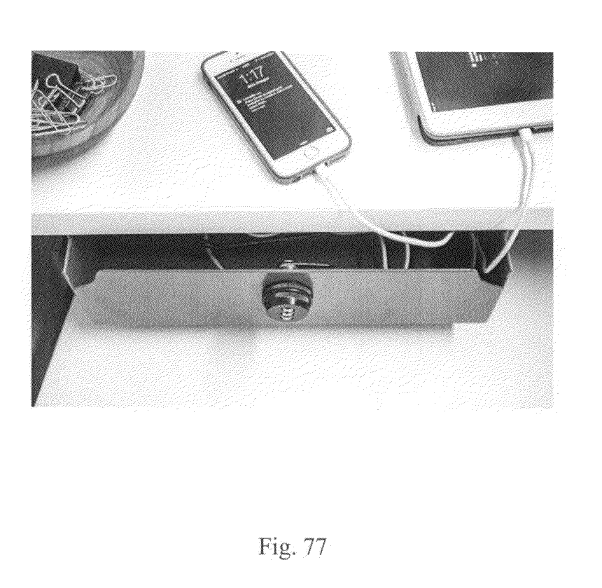

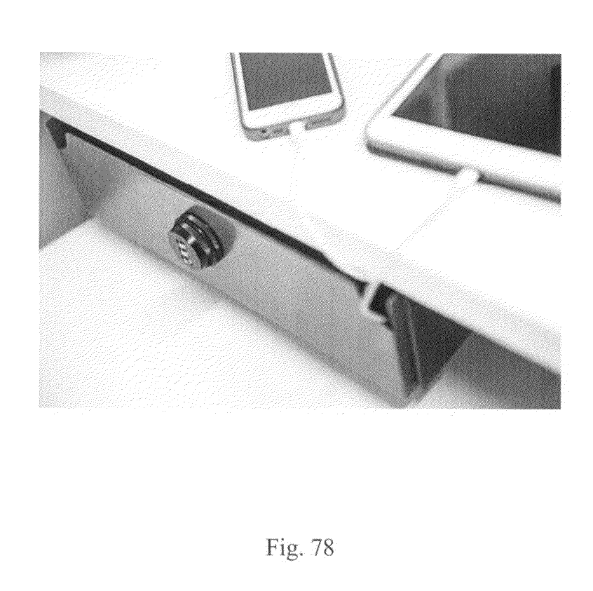

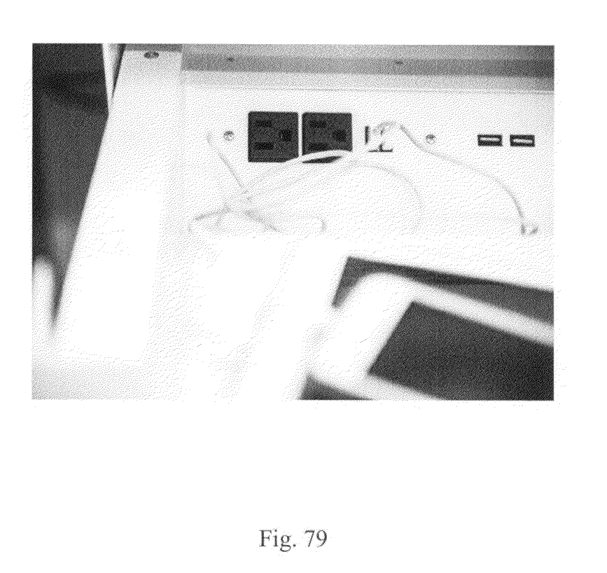

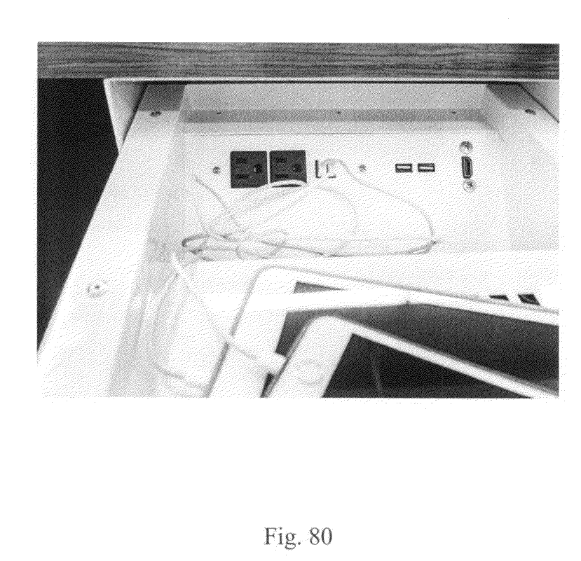

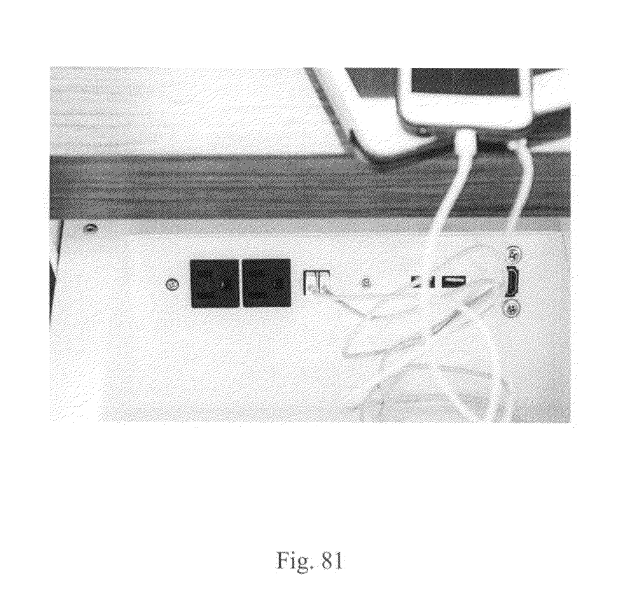

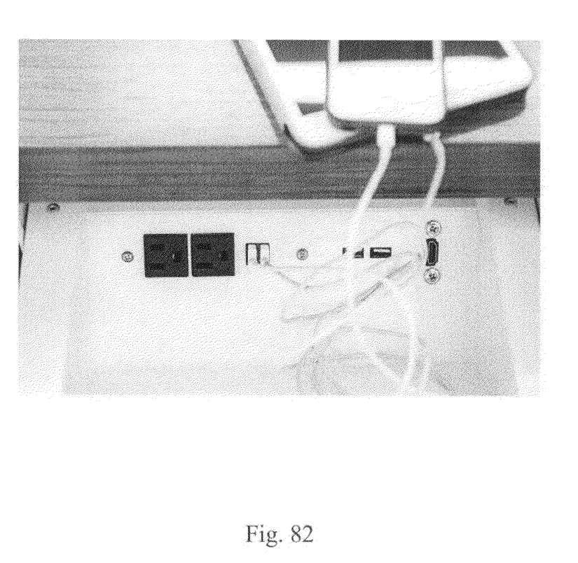

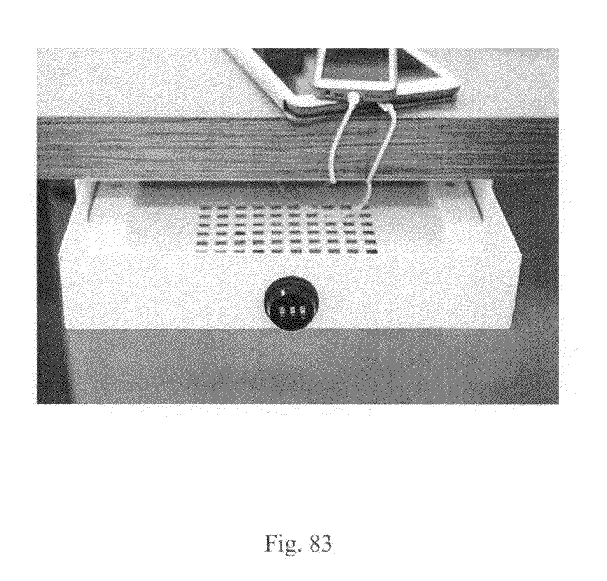

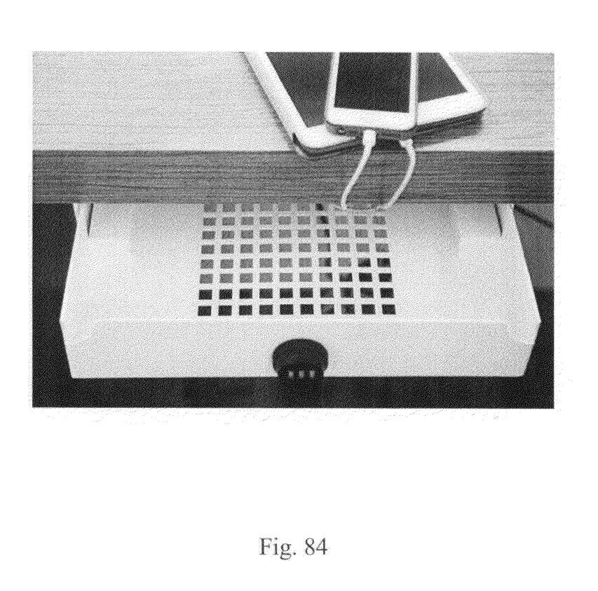

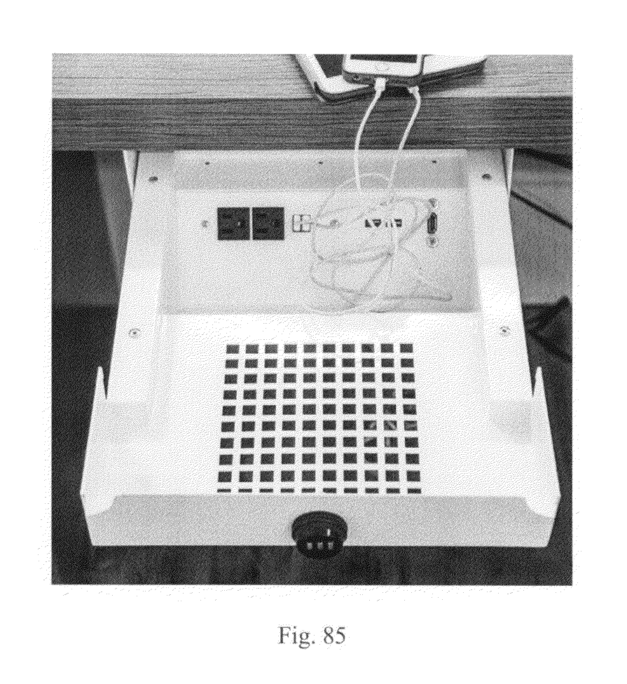

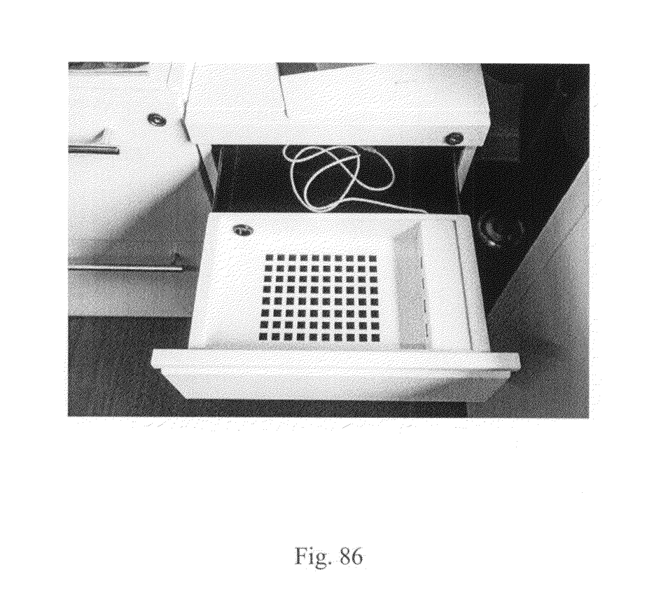

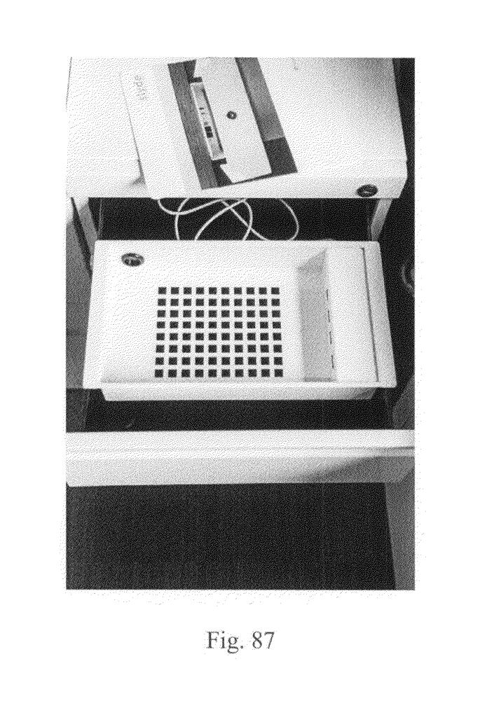

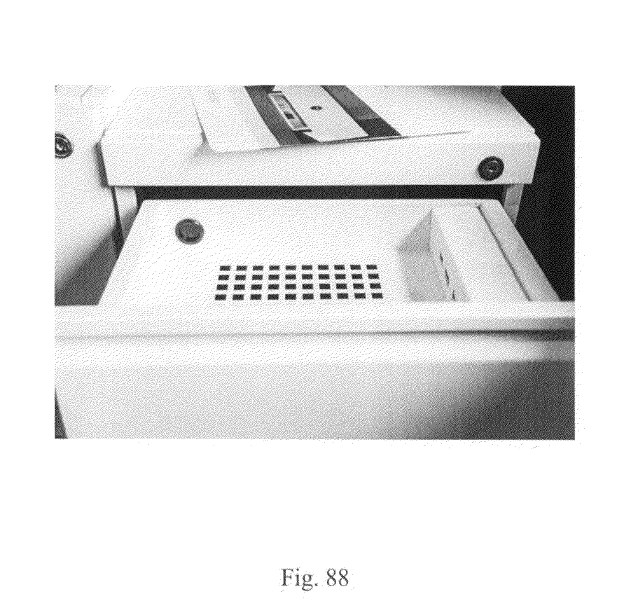

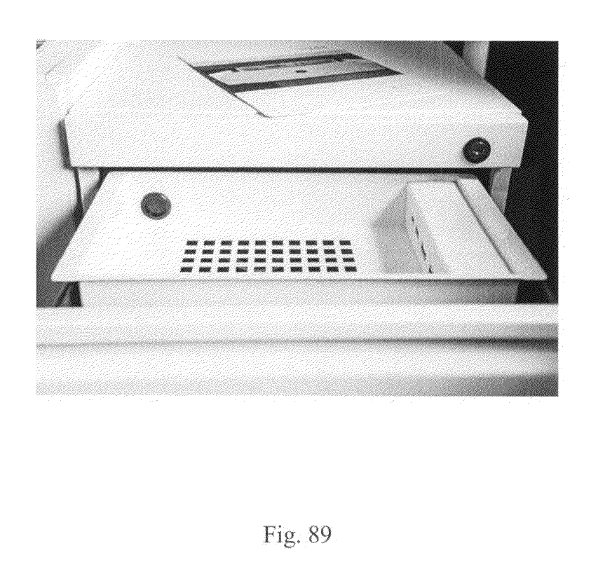

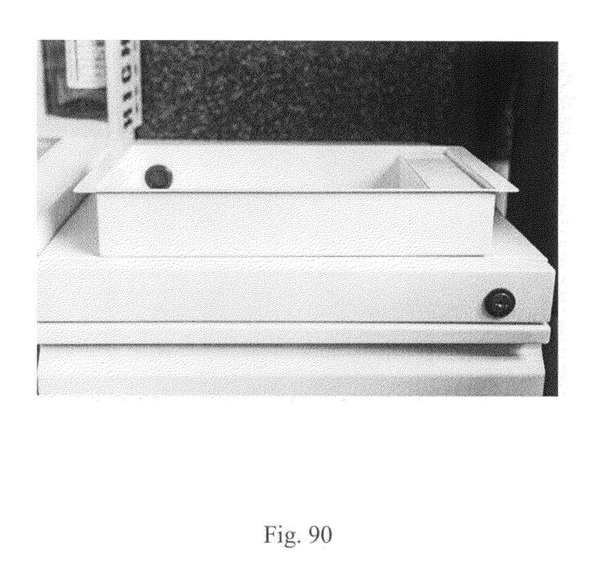

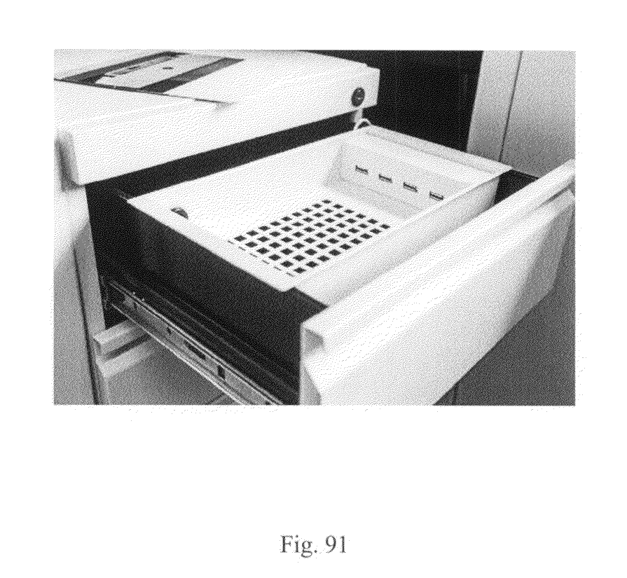

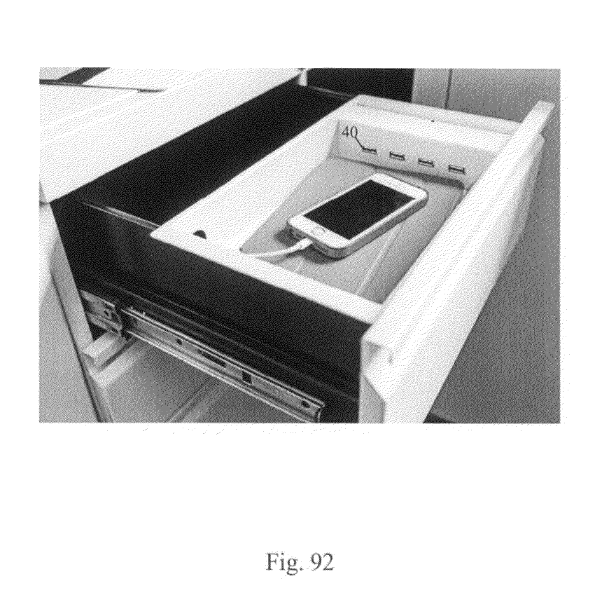

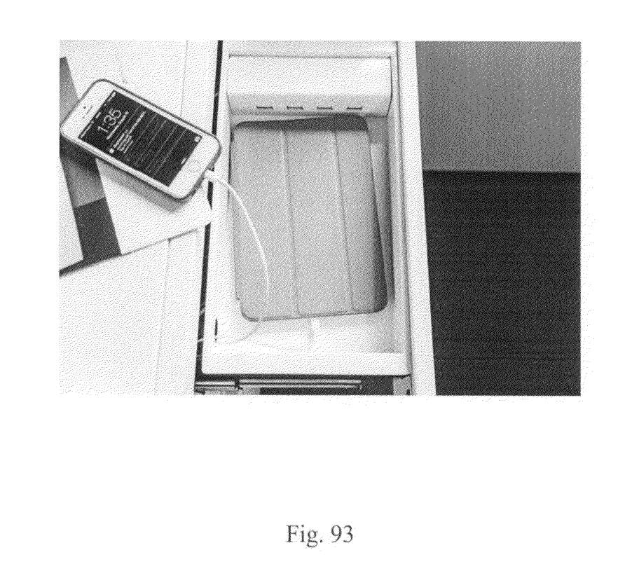

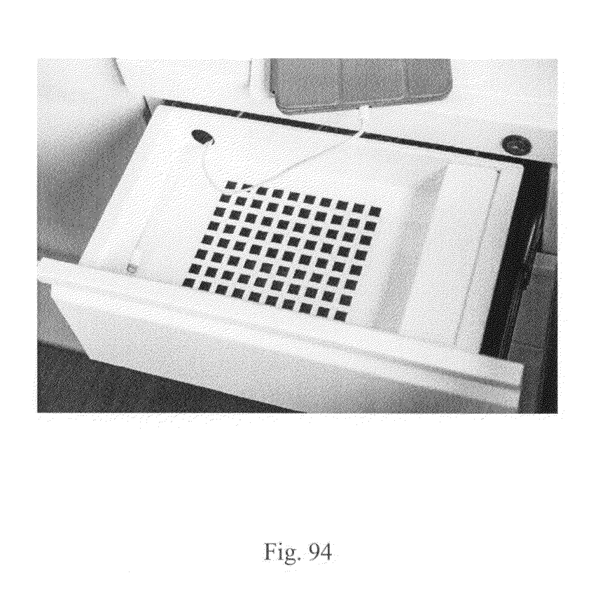

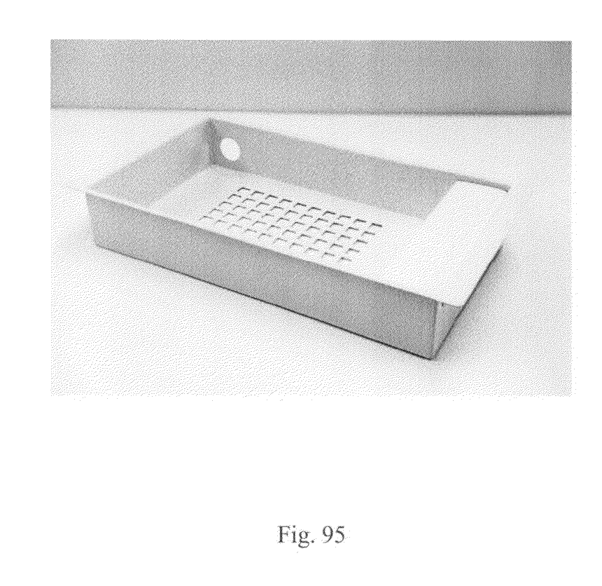

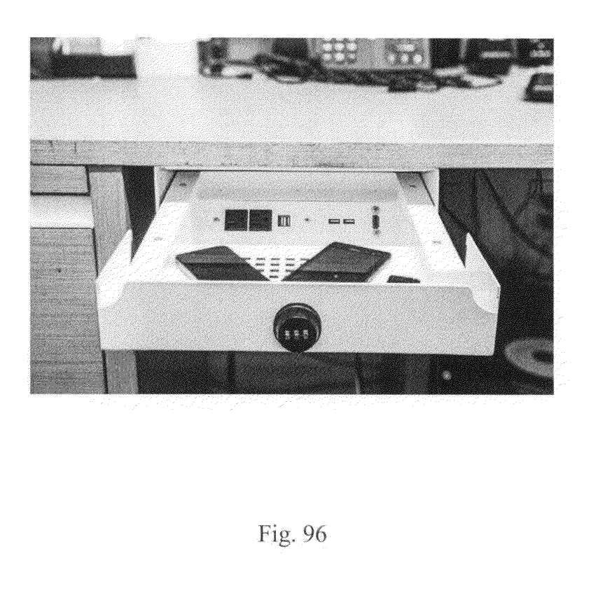

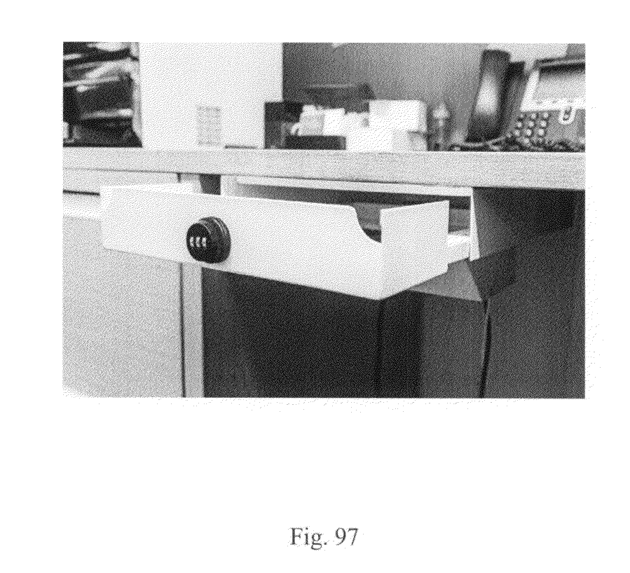

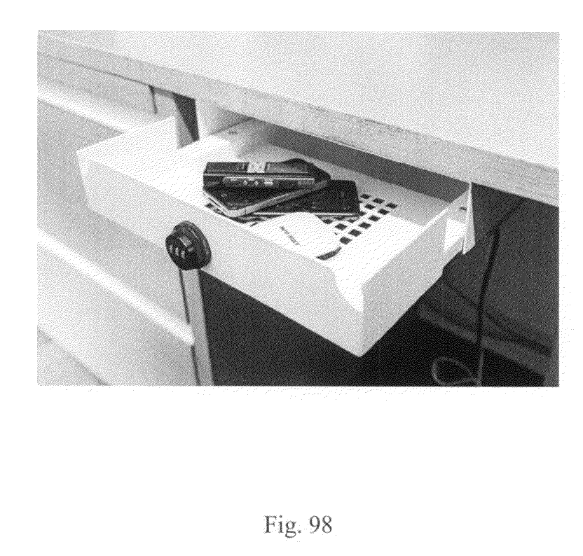

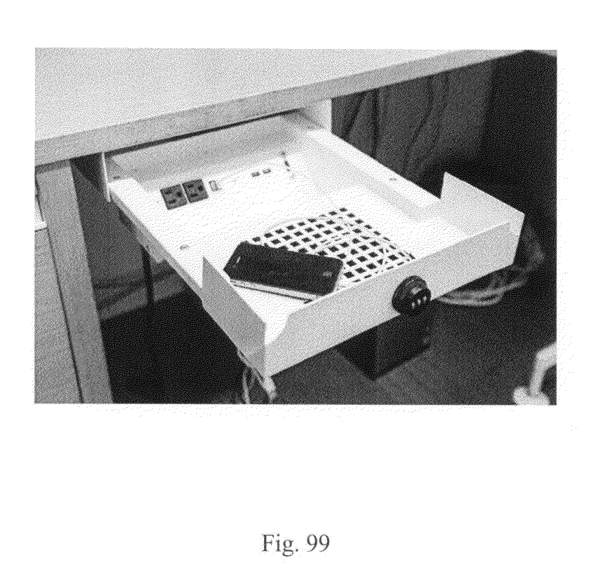

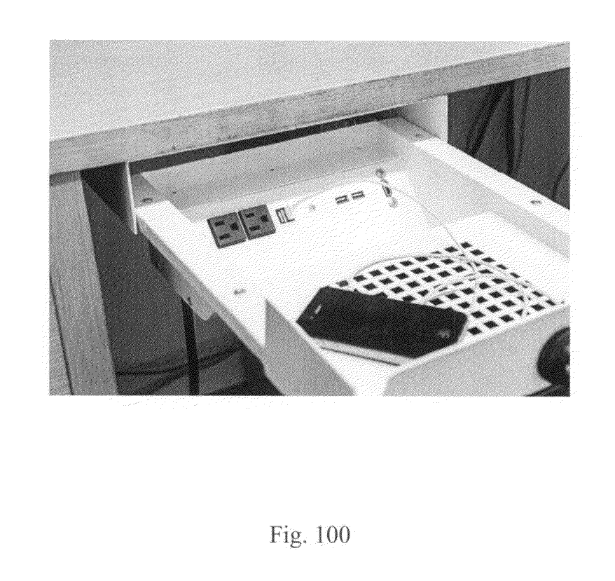

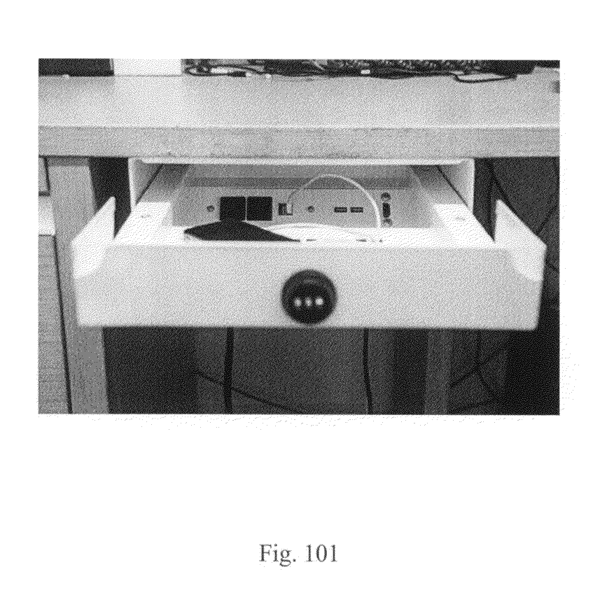

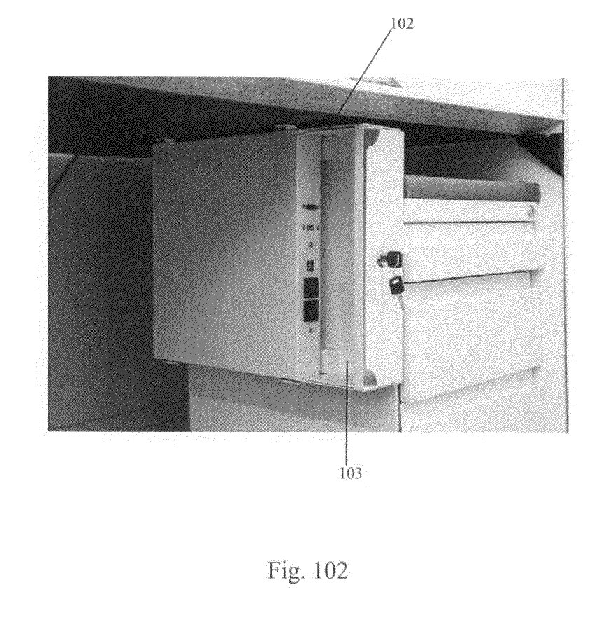

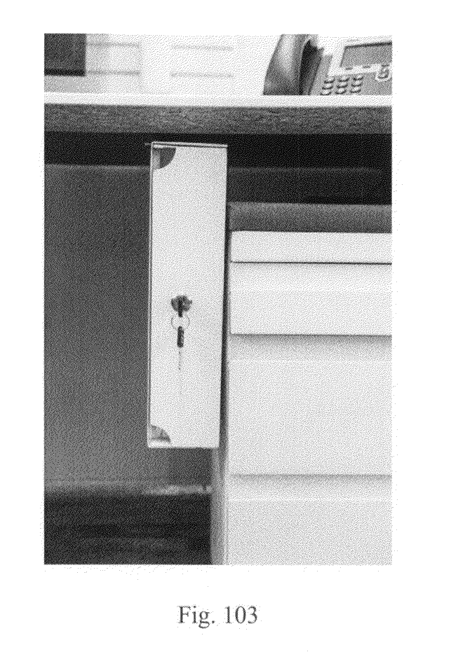

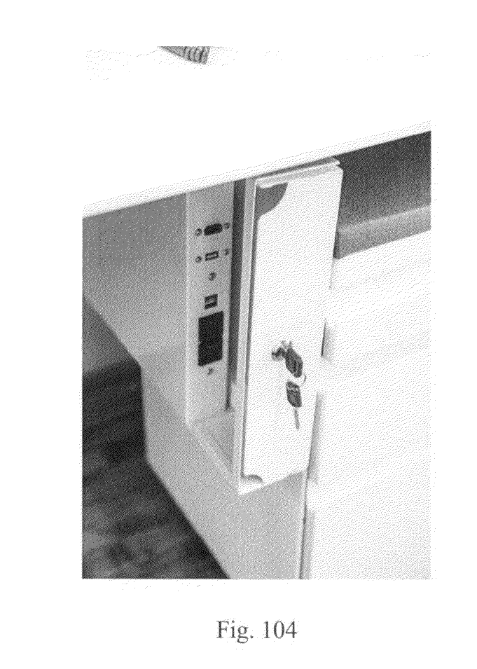

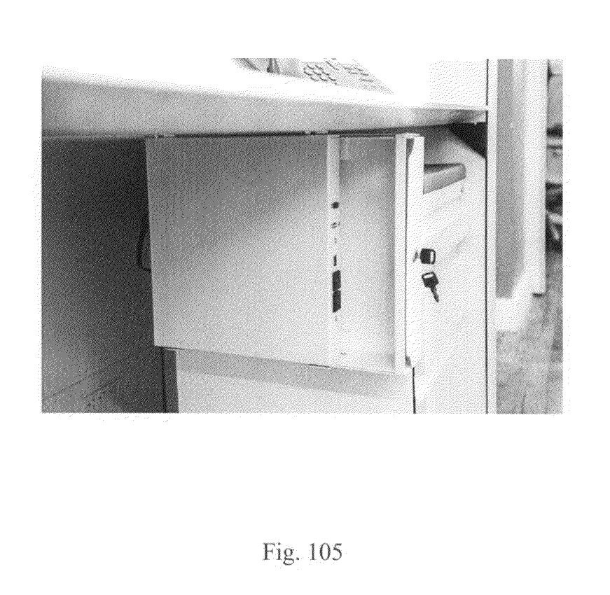

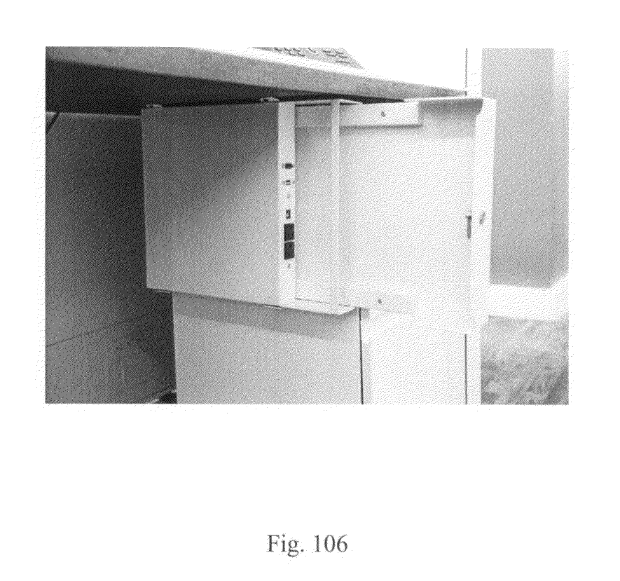

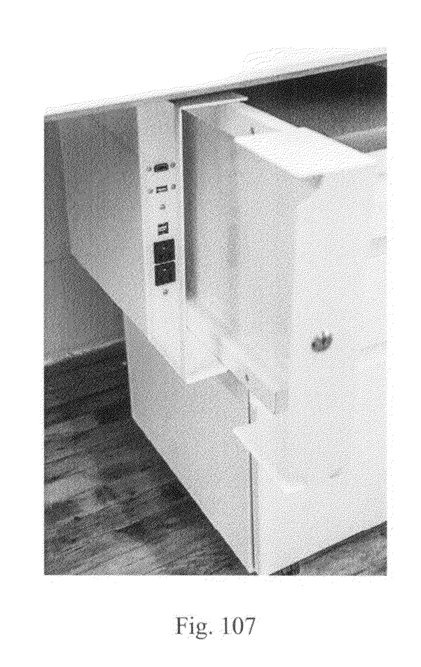

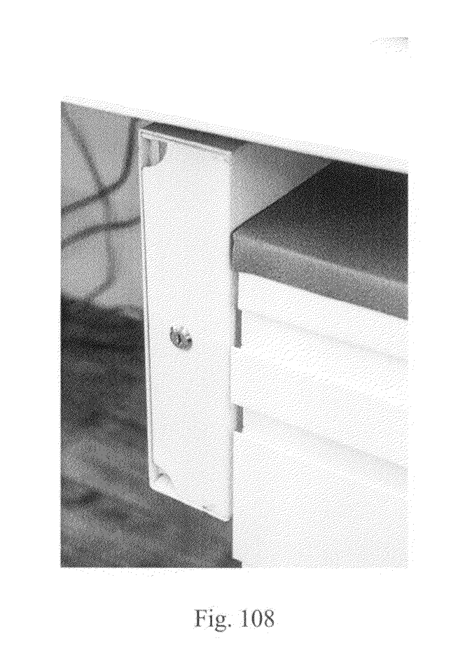

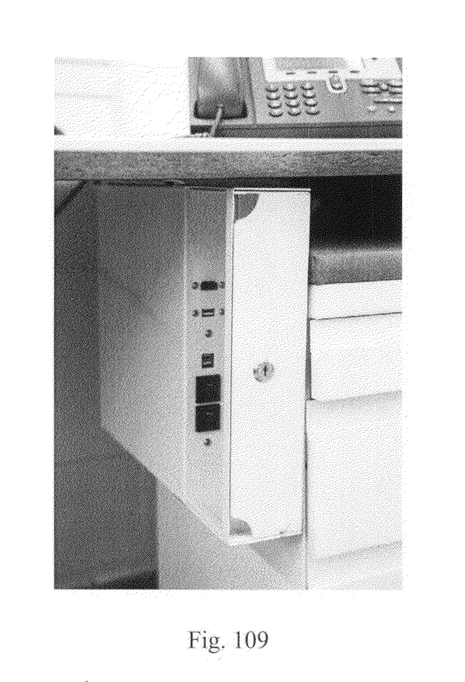

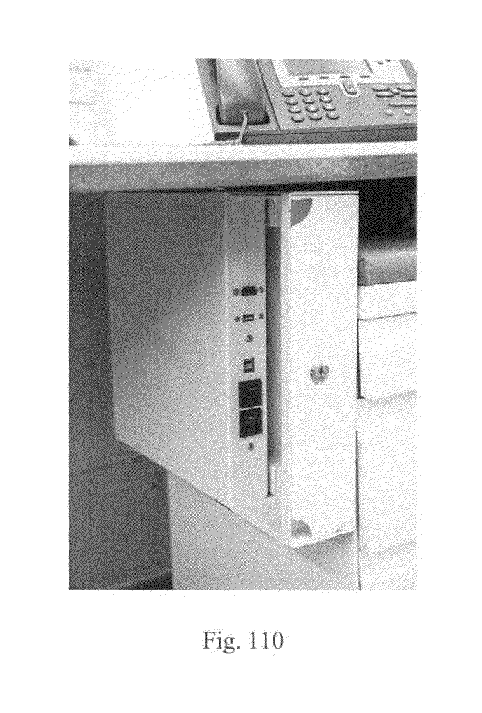

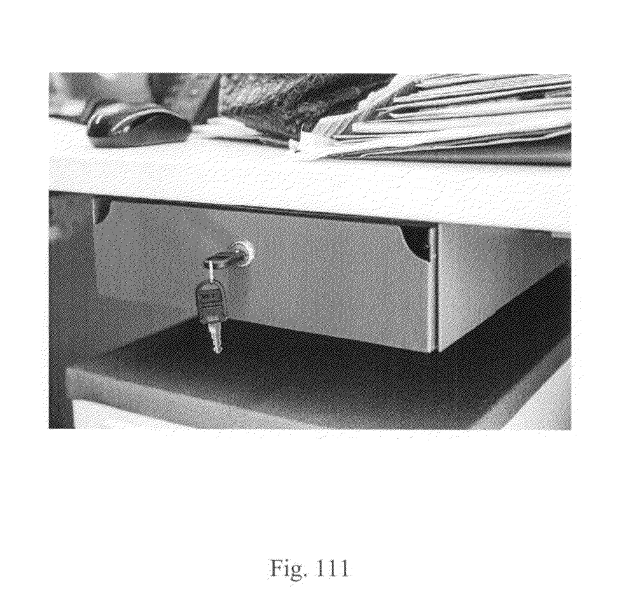

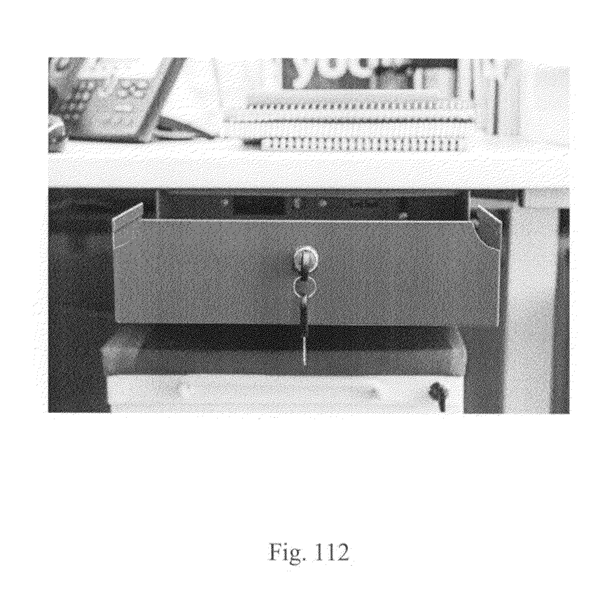

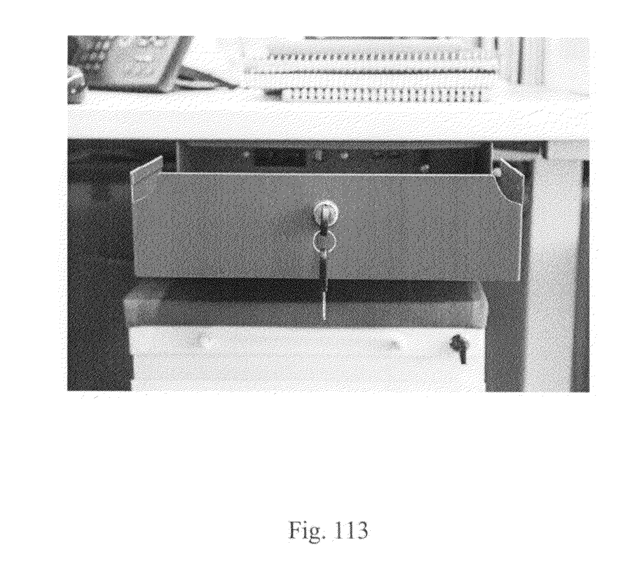

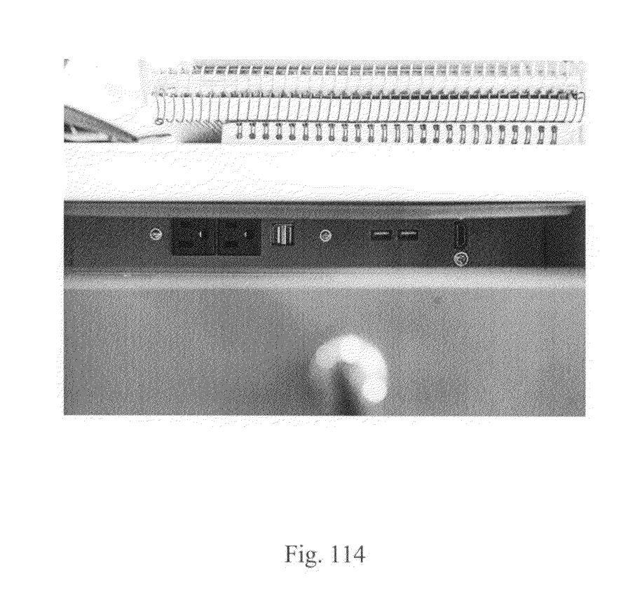

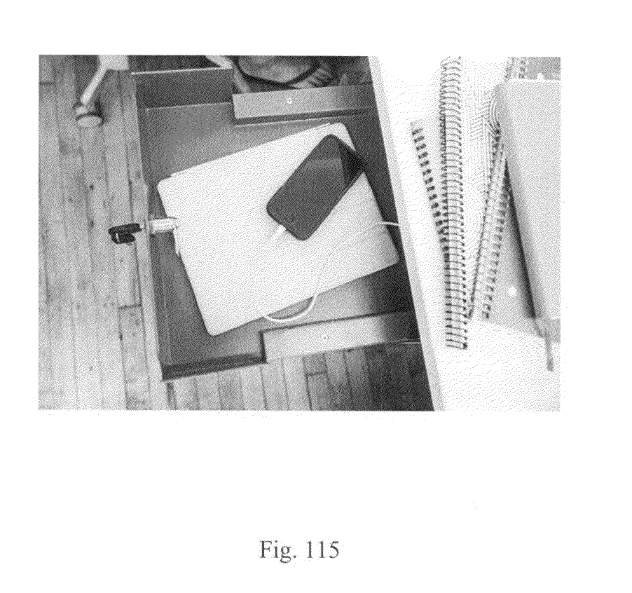

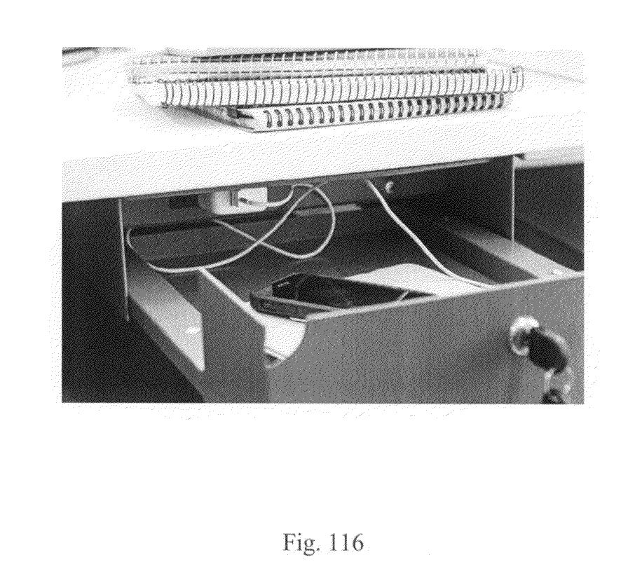

According to a further aspect of the disclosure, a drawer insert that includes an electronic panel 40 as described herein may also be provided. As illustrated, for example, in FIGS. 8-11, drawer insert can include electronic panel 40. It will be understood that electronic panel 40 may include fewer, more of different plugs and ports than those illustrated, and that various electronic panel or portion thereof, and various other components and structures, or portions thereof, illustrated in the Drawings for one embodiment may be incorporated in other embodiments in addition to or instead of those shown.

FIG. 8 illustrates drawer insert 60 that is designed to be positioned in and secured to an existing conventional drawer.

FIG. 8 illustrates lip 61 of insert 60 that is designed to fit over conventional drawer lip 66. Conventional lip 66 may accommodate a conventional lip of prior art pencil insert/pencil and accessory holder.

Drawer insert 60 may be positioned over, snap onto or be otherwise secured onto lip 66 of the conventional drawer.

FIG. 8 also illustrates electronic panel 70 that may be positioned in various ways in drawer insert 60. FIG. 8 illustrates electronic panel 70 as having electric outlets 45a and 45b and various electronic ports, jacks and connections 47a, 47b and 47c mounted parallel to the front of the drawer. Inner space 63 is thus created behind electronic panel 70, and may house various types of laptops or other personal computing devices, as well as smaller handheld devices, such as personal organizers, personal music players, including iPods, iPads and the like, mobile telephones, including smartphones, netbooks, tablets, e-readers, electronic pads, as well as accessories for such devices, including electronic chargers, cords, joysticks, keypads, keyboards, headphones, flash memories, satellite wands, carrying and protective cases, sheaths, and the like.

Illustrated in FIG. 8 by way of illustration are two electric outlets 45a-45b, Ethernet cable 47a, USB cable jack 47b and lightning port 47c. It will be understood however that more or fewer outlets and ports can be provided on electronic panel 70, and that other kinds of electronic outlets, such as European or Asian style electronic outlets, including outlets that provide more or less than 120 volts, such as 220 or 210 volts, direct current, and the like can also be provided. In addition, a lightning jack, or a fire wire port, telephone jacks, one or more jacks for headphones, microphones or speakers, a coaxial cable, HDMI ports or the like, that can be provided in addition to, or instead of, the ports, connector jacks and outlets illustrated FIG. 8.

FIG. 8 also illustrates that drawer insert 60 has a bottom 64 that provides a shallower drawer configuration than the deeper portion of the drawer 62 that has no drawer insert. It will be understood that electronic devices and accessories therefore can also be positioned in front portion 62 of the drawer without the drawer insert 60 and such device can also make use of the electric outlets and electronic ports of electronic panel 70. While shown as a unitary electronic panel 70, it will be understood that electrical outlets, ports and jacks may be located on more than one panel of drawer insert 60.

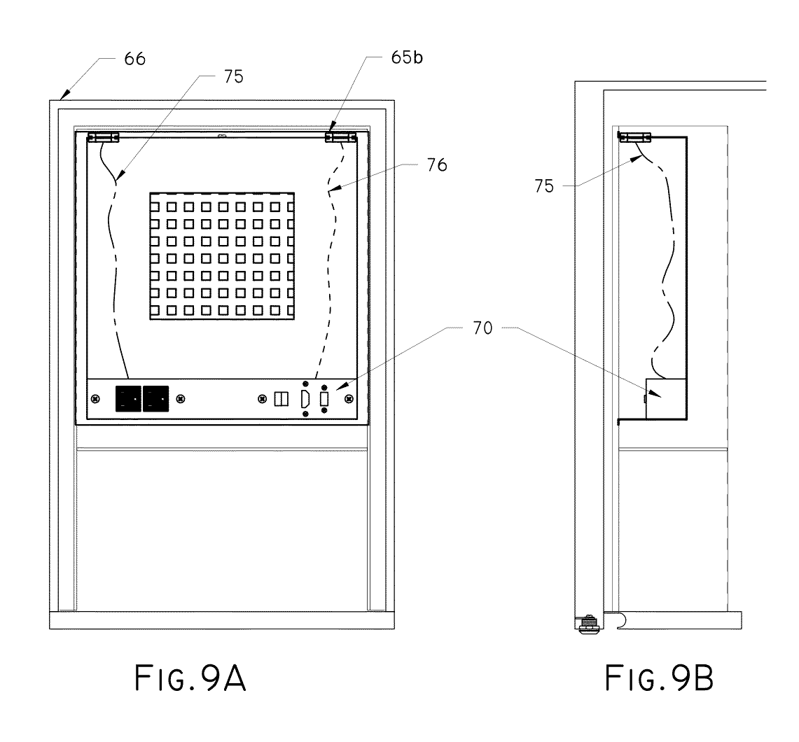

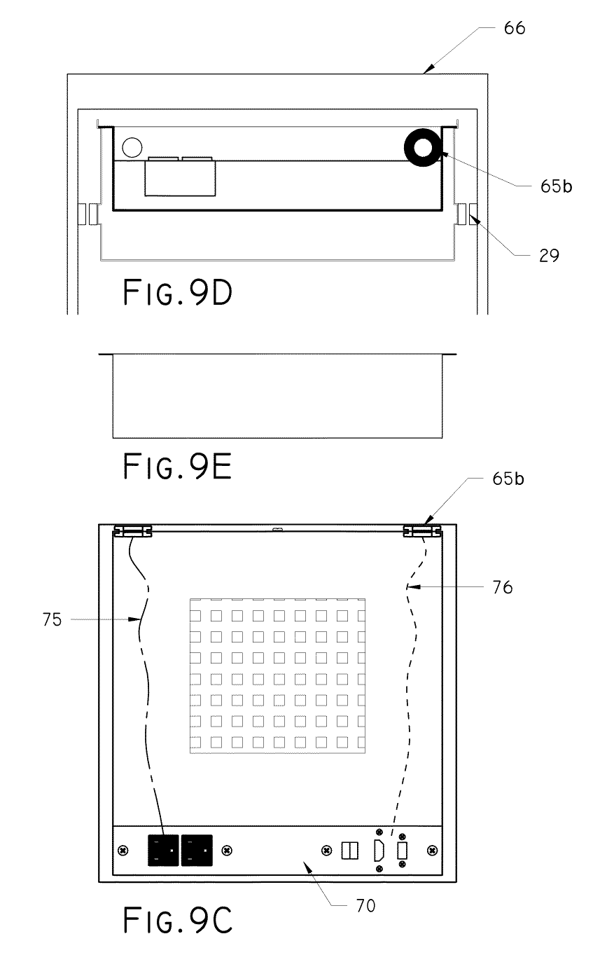

FIGS. 9A-9D illustrate dimensions of drawer insert 60. It will be understood, however, that these dimensions are provided only by way of example and that a person of ordinary skill in the art would readily understand that smaller or larger length, width, or depth for the drawer insert can be provided. For example, for the same conventional drawer, a drawer insert that is slightly longer or shorter with respect to the front to the back dimension of the drawer, a drawer insert that is less deep or more deep with respect to the top and bottom of the convention drawer are also contemplated and may also be provided.

FIGS. 9A-9D illustrate grommet 65b that may be positioned in grommet cutout 65a. More or fewer than the two grommets and grommet cutouts illustrated in FIGS. 8 and 9A-9D may be provided. FIGS. 9A-9D also illustrates receiving panel 71, which may be made of rubber, synthetic rubber, plastic, or the like, designed to prevent sliding of electronic equipment stored in the drawer insert, to prevent abrasion or scratching of electronic devices and to prevent static electricity or the like. Also illustrated in FIGS. 9A-9D is a wire or a cable or cord 72 that may be run from electronic panel 70 to the back of the drawer and through grommet 65b and hooked up behind the drawer to power outlet, power surge protector and the like.

Electronic panel 70 and/or drawer insert 60 illustrated in FIGS. 2 and 8, as well as the electronic panel an/or the drawer illustrated in FIGS. 1A-1H and in other figures, may also include a UPS (uninterruptable power supply) and/or a rectifier or an electric power converter, including an adjustable power converter, that converts voltage to a target voltage required by the electronic device or appliance in the drawer or drawer insert. For example, a standard 110 or 220 volt power supply may be converted by electronic panel 70 to a much lower voltage required by a portable or handheld electronic device. Panel 70 may also convert an AC voltage source to DC and vice versa.

FIGS. 11A-11F illustrate a side mounted electronic panel 70.

FIGS. 11A-11F also illustrate that electronic panel may include no electronic outlets, but only USB ports and/or lightning connector ports, firewire ports or the like. In this way, electronic devices stored in the drawer insert can be both charged and synchronized simultaneously. However, side mounted electronic panel 70 may have the same electric outlets and ports and jacks or may have a different combination of outlets, ports and jacks. Side mounted electronic panel 70 may make it convenient for the user to plug in electronic devices positioned inside the drawer insert. For example, a home or office computer, laptop, or the like may be positioned on top of a filing cabinet, and drawer insert 60 may be positioned in one of the drawers of the filing cabinet, such that the electronic device in the drawer insert can be both charged and connected to the computer or laptop near or in the vicinity of the drawer with the drawer insert. Vents may also be provided below drawer insert 60, or on the rear side where the grommets are situated or on a lateral side of drawer insert 60, and such vents or holes can be lined up with holes or vents of the drawer in which the drawer insert is inserted.

FIGS. 1A-1H illustrate a drawer with built in electronic panel 70. FIGS. 1A-1H illustrate that a recessed portion, lower portion or trough 73 or low portion of the drawer may be built in so that the electronic devices resting on surface 74 can be plugged into electronic outlets, ports and jacks just below the surface on which they rest. Channel 73 may be rectangular in shape or may be rounded near the bottom or near the top. FIGS. 1A-1H also illustrate that electronic outlets may be oriented at a 45° angle, or at some other tilted angle with respect to surface 74 of the drawer on which electronic devices rest. In this way, a sleeker more slender profile can be provided for the drawer as a whole, and the drawer can fit existing spaces that are smaller. For example, such a drawer can be mounted underneath a desk or the like.

FIGS. 1A-1H also illustrate ground wire 75 that may be attached to a grounding portion 77, attached, for example, at the rear side where the ground wire cutouts are located. It will be understood that grounding unit 77 may be positioned at other surfaces of the drawer or the cabinet to which the drawer is mounted or other adjacent surfaces so as to provide ground for the electric outlets. Grounding unit may be provided such that a purchaser or end user can adhere or otherwise mount it at a convenient location during or after installation.

FIGS. 8-9 illustrate a drawer insert configured to be positioned in existing drawer. The drawer insert includes lips that sit on top of, mount onto, snap onto or secure onto the top lips of the drawer, as described below. Drawers sometimes have a pencil insert and may thus have lips to accommodate such a pencil insert. Insert also includes electronic panel 40 with electronic plugs, USB ports and other charging ports, and/or the charging and/or synchronization ports, as described herein.

Although the present invention has been described in relation to particular embodiments thereof, many other variations and modifications and other uses will become apparent to those skilled in the art. It is preferred, therefore, that the present invention be limited not by the specific disclosure herein.

What is claimed is:

1. A drawer comprising:
a receiving area positioned at a front of the drawer and including a flat bottom extending along a first plane, the receiving area ending at a bottom transition area; and
a trough positioned rearward of the receiving area, the trough comprising:
a trough bottom positioned starting at the transition area and inclined down away from the front of the drawer at an angle substantially less than 90 degrees with respect to the first plane; and
an electronic panel including a surface comprising an electronic device charging port, the surface being positioned to align with a second plane inclining up toward a rear of the drawer, the second plane meeting the first plane at an angle substantially less than 90 degrees.

2. The drawer of claim 1, wherein the trough bottom is substantially 90 degrees with respect to the second plane.

3. The drawer of claim 1, wherein the trough bottom is substantially 45 degrees with respect to the first plane.

4. The drawer of claim 1, wherein the second plane is substantially 45 degrees with respect to the first plane.

5. The drawer of claim 1, wherein the charging port includes an electric plug.

6. The drawer of claim 1, wherein the charging port includes a synchronizing port.

7. The drawer of claim 1, wherein the charging port includes a USB port or an HDMI port.

8. The drawer of claim 1, further comprising a second flat bottom extending from the trough bottom to the rear of the drawer.

9. A drawer configured to be mounted underneath a work surface, the work surface supported underneath by a support bar, the drawer comprising:
a receiving area positioned starting at a front of the drawer and including a bottom; and
walls defining a recess positioned and configured to accommodate the support bar, the recess extending from a first lateral side of the drawer to a second lateral side of the drawer,
wherein the receiving area extends underneath the recess; and
an electronic panel comprising an electronic device charging port, the electronic panel positioned in the drawer.

10. The drawer of claim 9, wherein the electronic panel is positioned forward of the walls defining the recess.

11. The drawer of claim 9, wherein the charging port includes an electric plug.

12. The drawer of claim 9, wherein the charging port includes a synchronizing port.

13. The drawer of claim 9, wherein the charging port includes a USB port or an HDMI port.

14. A drawer insert configured and sized to fit inside a drawer having a lip, the drawer insert comprising:
a top portion comprising a top lip positioned and configured to secure on the lip of the drawer; and
an electronic panel comprising an electronic device charging port.

15. The drawer insert of claim 14, wherein the charging port includes an electric plug.

16. The drawer insert of claim 14, wherein the charging port includes a synchronizing port.

17. The drawer insert of claim 14, wherein the charging port includes a USB port or an HDMI port.

18. A drawer configured to be mounted vertically underneath a work surface, the drawer comprising:
a top side configured to be mounted to a surface underneath the work surface, and a lower side positioned opposite the top side;
a receiving area comprising a forward portion positioned starting at a front of the drawer and including a major wall positioned vertically, the major wall extending from the top side to the lower side; and
an electronic panel comprising an electronic device charging port,
wherein the electronic panel is positioned in the drawer forward of a rear of the drawer and recessed from the major wall, such that the receiving area extends between the electronic panel and the major wall, the receiving area configured to accommodate an electronic device positioned between the electronic panel and the major wall.

19. The drawer of claim 18, wherein the charging port includes an electric plug.

20. The drawer of claim 18, wherein the charging port includes a synchronizing port.

21. The drawer of claim 18, wherein the charging port includes a USB port or an HDMI port.
